(19) United States
(12) Patent Application Publication
(10) Pub. No.: US 2013/0185750 A1
(43) Pub. Date: Jul. 18, 2013

(54) CONTEXT BASED CORRELATIVE TARGETED ADVERTISING

(71) Applicant: Ramy S. Ayoub, Arlington Heights, IL (US)

(72) Inventor: Ramy S. Ayoub, Arlington Heights, IL (US)

(73) Assignee: General Instrument Corporation, Horsham, PA (US)

(21) Appl. No.: 13/351,901

(22) Filed: Jan. 17, 2012

(51) Int. Cl. H04N 21/25

(52) U.S. Cl. 725/34

(57) ABSTRACT

A method for selectively distributing content from a backend content distribution system (CDS) to at least one subscriber device includes: receiving information from a monitored environment corresponding to a subscriber device of the at least one subscriber device; correlating, using a processor of the backend CDS, a context identified by the received information to one or more specific content; inserting the specific content into a content stream being transmitted to the subscriber device; and transmitting along with the specific content at least one of (a) correlative information explaining a context surrounding why the specific content is being presented and (b) a selectable affordance by which access to the correlative information is provided. The received information includes at least one of (a) sensor information received from a sensor located within the monitored environment and (b) detected subscriber behavior captured by the subscriber device, and (c) subscriber-provided context information.

### BACKGROUND

1. Technical Field

The present invention generally relates to content distribution systems and in particular to content distribution systems that provide content to a subscriber device at a subscriber location.

2. Description of the Related Art

Many traditional audio and video content distribution systems, such as those utilized by cable and satellite television (TV) providers, provide pre-programmed and/or pre-scheduled content to an end user via a subscriber device. Usually, the subscriber device is associated with a particular subscriber or user and located within a subscriber environment, which can include the subscriber's home, office, and/or vehicle(s). Content sent to the subscriber device may originate from traditional service provider networks or Over the Top (OTT) sources on the Internet. Users predominately consume content within the home, but there are a growing number of users consuming content on mobile devices such as smart phones and tablets computers.

Within a growing number of these controlled subscriber environments, there is an ever expanding ecosystem of sensors and monitors that are physically located within and/or surrounding the environment of the end users and/or the subscriber devices. Additionally, many of the devices that are used to conduct everyday activities, such as cell phones, Set Top Boxes (STBs), and tablet personal computers (PCs), are designed to be capable of being used as a sensor and/or monitor within the device user's environment. These user environments that can have monitoring sensors are not limited to the home, but can also include the user's office and/or the user's automobile among other locations. This ecosystem of sensors and monitors can collect data on and/or about the users, the users' environment, the users' behaviors, and the users' activities. These monitoring devices and sensors are occasionally utilized to provide environmental and contextual data from within and around the user's home to one or more third party service providers.

In-home monitoring devices and/or sensors are one common form of these environmental sensors. These sensors can detect conditions such as temperature irregularities in a home, detected by one or more thermostats, and high carbon monoxide levels in the home, detected by a carbon monoxide sensor, for example. Collectively, the various types of monitors and sensors within the subscriber's environment can provide a lot of information about a user and the user's environment.

### BRIEF DESCRIPTION OF THE DRAWINGS

The description of the illustrative embodiments is to be read in conjunction with the accompanying drawings, wherein:

FIG. 1 illustrates a generalized content distribution landscape with interconnected components of a content distribution system (CDS) and an example subscriber environment, in accordance with one or more embodiments;

FIG. 2 is a block diagram illustration of an example data processing system within which certain functions of an example CDS can be implemented, in accordance with one embodiment;

FIG. 3 is an example subscriber-context mapping table maintained within a subscriber information service (SIS) database by a SIS of the CDS, according to one embodiment;

FIG. 4 is a block diagram illustrating components of a SetTopBox (STB) and connected output device according to one embodiment;

FIG. 5 illustrates an example display screen presenting a visual output of specific content and correlative information corresponding to the presentation of the specific content, according to one embodiment;

FIG. 6 illustrates the example display screen of FIG. 5 providing an icon and a visual request for selection in place of the correlative information, according to one or more embodiments;

FIG. 7 illustrates the example display screen of FIG. 5 with the correlative information supplemented with a user feedback bar that allows a user to modify one or more contexts related to the displayed content and the correlative information, according to one or more embodiments;

FIG. 8 is a flow chart depicting the method by which specific content is selected and correlative information is generated and transmitted based on received contextual information, according to one embodiment;

FIG. 9 is a flow chart depicting the method by which the CDS transmits a unique identifier (ID) in lieu of the correlative information and subsequently utilizes the unique ID during processing, according to one or more embodiments;

FIG. 10 is a flow chart depicting the method by which a CDS modifies context relationships of a subscriber within the SIS database based on received feedback responses from the user and/or subscriber environment, according to one or more embodiments; and

FIG. 11 is a flow chart illustrating one method for determining how and when to transmit an icon or selectable affordance in place of the correlative information, according to one embodiment.

### DETAILED DESCRIPTION

The illustrative embodiments provide a method and content distribution system (CDS) that associate environmental and user-provided contextual data to a subscriber and/or user of a subscriber device located within a subscriber environment. The embodiments further provide that the CDS utilizes the contextual data to select specific targeted content (e.g., advertisements and promotions) to present to that subscriber, depending on context. Additional aspects of the embodiments further provide that the CDS provides correlative information that is presented to the specific subscriber or user(s) through supplemental information presented during the presentation of the select targeted content.

In one implementation, the method generally includes: receiving information about a context of a monitored environment corresponding to the subscriber device, where the received information has at least one of (a) sensor information received from a sensor located within the monitored environment, (b) detected consumer behavior captured by the subscriber device, or (c) subscriber provided context information. The method also includes correlating, using a processor of the CDS, the context identified by the received information (and stored context information, in one embodiment) to one or more specific content. The method further includes: inserting the specific content into a content stream being transmitted to the subscriber device; and transmitting along with the specific content at least one of (a) correlative information explaining a context surrounding why the specific content is being presented and (b) a selectable affordance by which access to the correlative information is provided. The CDS includes a plurality of functional components that collectively performs the above method functions, as well as additional functions as described herein.

The present disclosure provides a set of generic terminology to reference the main concepts of the embodiments and then relies on specific terms to explain a particular example and/or implementation of the described concepts. For example, “specific content” is generally utilized to refer to content that is selected based on an analysis of the contextual information received from the various sources. However, within the particular examples, the specific content can be described as “targeted advertising” and/or “targeted content”, referring to the fact that the advertising and/or content is selected to target the particular subscriber and/or user of the subscriber device based on the received contextual information. Similarly, the content selection mechanism introduced in the general content-level implementation can be described as an Advertising (Ad) Decision Server, when the specific content is advertising content.

Within the described embodiments, reference is made to specific examples of the application of the described method and system to correlate targeted advertising to specific context data associated with a subscriber device or user and to provide correlative information along with selected targeted advertising content in order to enhance the effectiveness of the targeted advertising. Among the motivation for these specific implementations of the described embodiments is the awareness that most of the subscriber devices are utilized within a subscriber environment that contains an ecosystem of at least one monitor and/or sensor. The embodiments then present an appreciation that the user data from these various sensor devices can be very valuable to advertisers, manufacturers, and service providers. As a result, many content providers and/or advertisers have been increasing their ability to collect data on users in order to refine the services, content, and/or advertisements presented to the users. As this wealth of data for a single consumer or subscriber becomes more readily accessible, this collection of data can lead to some confusion about a user's preferences and likes, and can be subject to misinterpretation, leading to incorrect targeting of content. Thus, the analysis of the sensor data and the associated correlative algorithms that are utilized to correlate the results of the analysis to a specific user could be adaptive in order to accurately target the correct user(s). Further, it is very likely that a user of a particular subscriber device might not know and/or appreciate that the specific content is intended for that user, and whether the user is expected to respond in some way to the presented advertising. For example, the user may be unaware of the collection of sensor-detected information or sensor-based contextual data and/or that the advertising content being presented is tied to such sensor-detected data. Aspects of the described embodiment enable the CDS to eliminate the guesswork involved in the user's determination and/or understanding of why a particular targeted content is being presented to the user via the user's subscriber device.

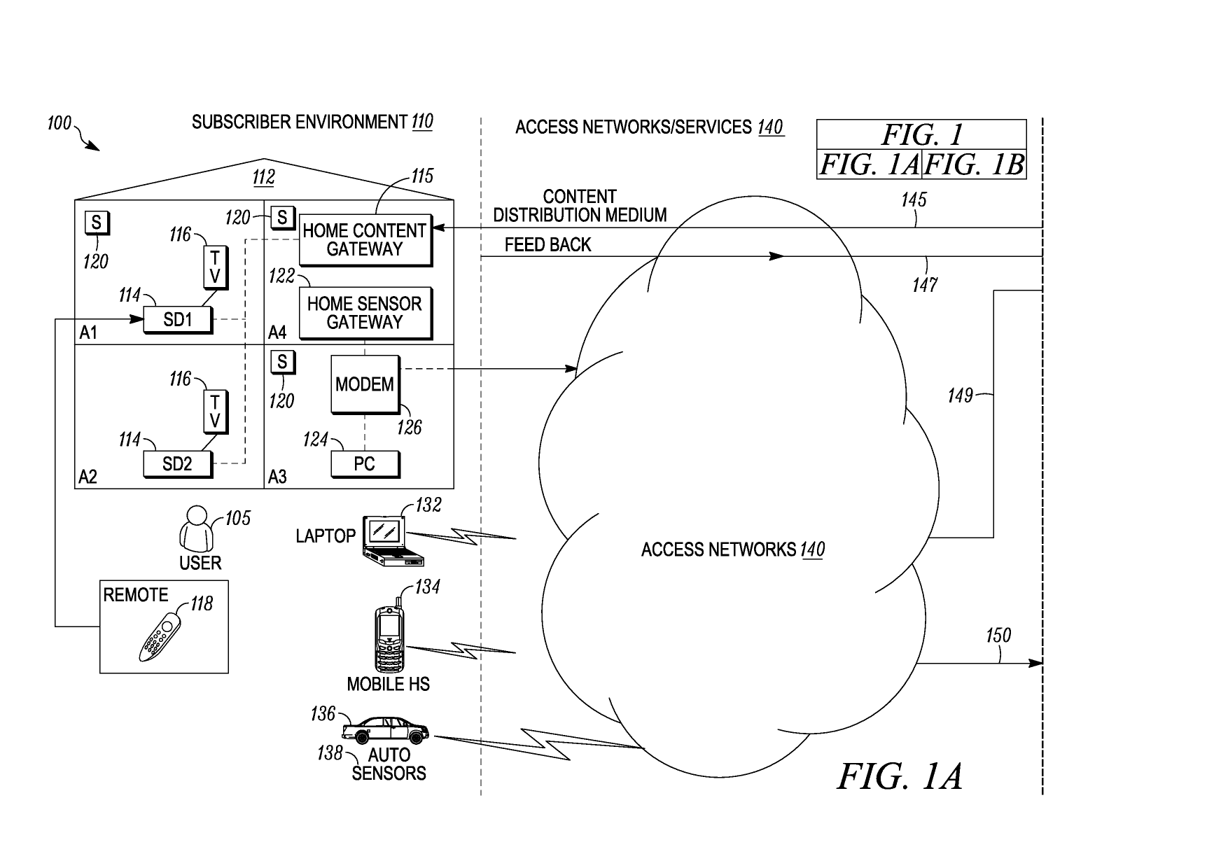

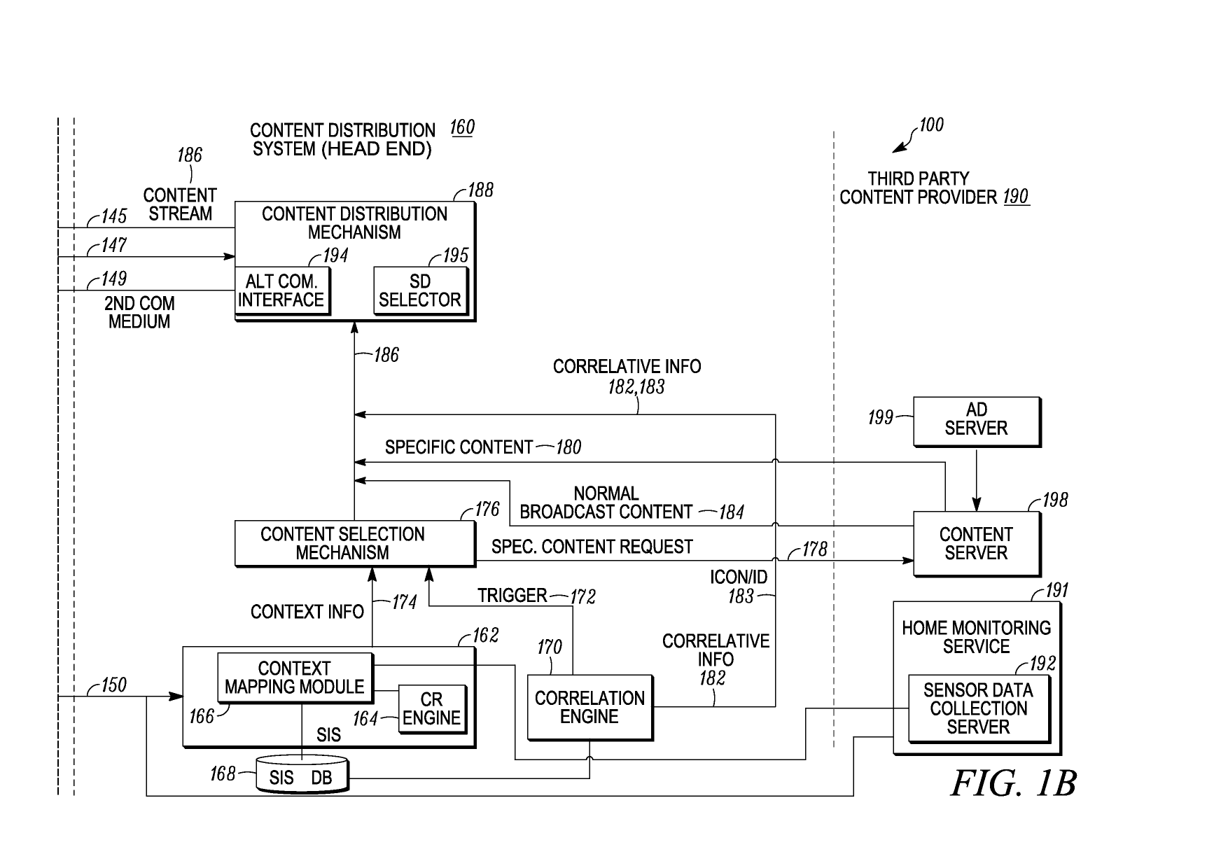

FIG. 1 depicts an example general content distribution system landscape 100. To facilitate the numerous uses of the term content distribution system within the disclosure, the term content distribution system will hereinafter be referred to by the acronym CDS. It is appreciated that the term CDS and specifically as it refers to the functionality provided by CDS 160 (FIG. 1) and/or data processing system (DPS) 200 (FIG. 2, described below) can refer specifically to what is conventionally known as a head end for large scale content distribution services. The term CDS is assumed to be more expansive in coverage and can include relatively small-scale distribution systems as well. CDS landscape 100 is illustrated as a plurality of physical and functional components that make up examples of subscriber environment 110, CDS 160, and connecting access networks 140. The sets of components respectively representing core segments of CDS landscape 100 are delineated with a dashed vertical line, which can be construed as representing both a functional as well as a physical separation. It is appreciated that these vertical lines are imaginary constructs that do not necessarily represent the manner in which the separate components would be aligned relative to each other in any particular implementation of a CDS landscape. As an example, in a most basic form of this CDS landscape, the devices within subscriber environment 110 that provide contextual information to the content distribution system (CDS) 160 can all be directly connected via a single communication path and/or medium to CDS 160, providing a very basic implementation of access networks 140. Such details will become clearer in the following description. For clarity, CDS landscape 100 shall be described sequentially from the leftmost column, representing subscriber environment 110, across to the rightmost column, third party content providers 190, with some overlaps where necessary to explain a connection of or association between components.

Subscriber environment 110 is generally illustrated as including user 105 (or subscriber) and a home location 112, which can be a house, apartment, condo, office, or other physical structure or physical location at which one or more subscriber devices 114, e.g., a Set Top Box (STB), is physically located. Subscriber device 114 has an associated subscriber device identifier (ID) (not shown) that can be associated with the user 105. More than one user 105 can be present within subscriber environment. As presented herein, one or more unique identifiers can be utilized within specific embodiments to identify one of the subscriber, the subscriber device(s), or the user(s) of the subscriber devices. Thus, as one aspect of the embodiments, the context can be based on and thus be associated with a particular subscriber ID, which is the single ID that is generally associated with the subscriber environment and/or with the subscriber account through which the service is established (e.g., the unique account number utilized for billing purposes).

In another aspect, the content can be based on and thus associated with a subscriber device, where a single subscriber environment can have multiple subscriber devices each having a unique subscriber device ID (e.g., a separate ID identifying the living room TV, the bedroom TV, the Dad's mobile, the Mom's mobile, and a child's mobile). In yet another aspect, the content can be based on and thus associated with a specific user within the subscriber environment, and the user ID can relates to, for example, a Dad's ID, a Mom's ID, and a child ID, where each user can utilize a same subscriber device. In particular, when multiple user IDs are associated with a single subscriber device and the context information is correlated at the granularity of the individual users, the time at which a particular user receives content from the subscriber device is tracked and applied to the context information at the user ID level. It is appreciated that while aspects of the disclosure are described from the perspective of a subscriber and/or subscriber device, each subscriber account can be assumed to have at least one user ID associated therewith.

Returning to the figure, for purposes of the description herein, the subscriber device 114 is assumed to be a STB that delivers multimedia content (e.g., video and audio) to an output device 116, which is illustrated as being a television (TV) set. It is appreciated that, in alternate embodiments, the output device 116 can be a video display monitor, such as a computer monitor, rather than a full stand alone TV. Home location 112 can have multiple different areas or rooms, of which four areas are illustrated. To simplify the description, these four areas are described counterclockwise from the upper left section of home location 112 as Area1 (A1), Area2 (A2), Area3 (A3), and Area4 (A4). Area1 includes a first subscriber device (SD1) 114 and a first output device (TV) 116, which is communicatively coupled to the first subscriber device 114. Area1 also has a first sensor (S) 120. Subscriber device 114 has an associated input device 118, which is illustrated as a remote control. Input device 118 enables a user 105 of subscriber device 114 to provide selections of different channels and change operating features of subscriber device 114. In one embodiment, input device 118 also enables a user 105 to make a manual input of context information and/or a feedback response to displayed content, as described later.

Area2 has a second subscriber device 114 communicatively connected to a second output device 116. In the illustrative embodiment, in which multiple subscriber devices 114 are present within the home location 112, certain of the below described features can be implemented at the granularity of each subscriber device 114 and can, in some instances be implemented at the granularity of the user or users that are associated with the different subscriber devices. Each subscriber device 114 has a corresponding subscriber device identifier (ID), and in some embodiments, each user can also be associated with a different user ID for context tracking purposes. The general description of the embodiments will however be described from the perspective of a single subscriber device that is associated with a single subscriber and/or a single user. The single subscriber device has a single subscriber device ID, and the associated single subscriber can have a subscriber ID and/or a user ID.

Area3 has a second sensor 120 and a personal computer 124. In one implementation, personal computer 124 also includes an internal tracking mechanism by which certain usages of the personal computer, e.g., websites visited, can be tracked and reported to the SIS 162 as context data. Area3 also has a modem 126 which enables personal computer 124 to connect to an external communication network, such as the Internet (not shown) via an Internet service provider.

Area4 has a third sensor 120 and a home sensor gateway 122. Home sensor gateway 122 represents a collection point at which data representing events and/or conditions detected by one or more sensors 120 located throughout the home location 112 are collected. Home sensor gateway compiles and/or packages the received sensor data and forwards the data to a sensor data collection server, such as server 192 of home monitoring service 191. The modem 126 may be used to send home sensor gateway 122 information to the SIS 162 and/or a home monitoring service 191. While illustrated as a service within third party provider 190, the functionality associated with sensor data collection server 192 and/or home monitoring service 191 can be provided as a service within CDS 160. In one example, home monitoring service 191 can be a security alarm company or a company established to provide a proprietary monitoring service for homes equipped with smart technology that includes the sensors 120. When sensor data collection server 192 is a server of a third party home monitoring service 191, sensor data collection server 192 forwards relevant environmental data to subscriber information service (SIS) 162 within CDS 160, for processing as described below.

It is appreciated that the depiction of a single home sensor gateway 122 is simply representative of potentially multiple different devices that support the monitoring functions of specific sensors 120 located within the home, and possibly office, location 112. The various sensors 120 located throughout home location 112 detect, sense, and/or record specific events and/or conditions within the home location 112, and the sensed or detected information can be forwarded to subscriber information service (SIS) 162 via home sensor gateway 122 and/or one or more of the access networks 140. As an example, one or more of the sensors 120 can be a temperature monitoring sensor (or thermostat) that monitors an ambient temperature within the home location 112 or within a specific area of the home location 112. The temperature monitoring sensor then forwards temperature readings to the home sensor gateway 122, which can incorporate intelligence to detect when the temperature is fluctuating or getting too cold or too hot relative to some pre-established threshold(s). The home sensor gateway 122 can then forward specific data to the SIS 162, which data is interpreted by the SIS 162 to represent the specific sensed temperature fluctuations. In the illustrative embodiment, the data representing the detected and/or sensed events and conditions are transmitted via some pre-established communication mechanism and/or service, generally illustrated as access networks 140.

Area4 also has a home content gateway 115, which distributes, via wired or wireless connections throughout the home location 112, incoming content received from CDS 160 to different subscriber devices 114 located within the home location 112. In one implementation, home sensor gateway 122 can be communicatively coupled to modem 126 and/or home content gateway 115 to communicate sensed data out from the home via one or more access networks 140.

As described herein, subscriber environment 110 represents a somewhat fungible ecosystem within which at least one subscriber device 114 is located, and subscriber environment 110 can extend from the physical location (e.g., home location 112) of the subscriber device 114 to other locations within which the subscriber, or one of the users of the subscriber device, can be tracked by one or more other sensors. In the illustrative embodiment, subscriber environment 110 has laptop computer 132 and mobile communication device (or mobile handset) 134, which are user portable devices that can be located in any of a number of locations in which the user is present. Each user portable device includes mechanisms for tracking and or recording certain contexts associated with the user and/or the user's current environment. Further, according to one embodiment, each user portable device is equipped with functionality to forward the tracked and/or recorded context data to SIS 162 via access networks 140, 150. The context data can be data that is provided or inputted by the user and/or data that is autonomously detected by the user portable device. This data may also be forwarded to home monitoring service 191.

Also included within the example subscriber environment 110 is a vehicle 136 that is owned by and/or utilized by the subscriber and/or user(s) 105. This vehicle 136 is generally represented as automobile, although other types of vehicles, including air, land, and sea crafts, for example, can be included within an expanded version of subscriber environment 110. Vehicle 136 includes one or more vehicle sensors, auto-sensor 138, which can detect certain events and/or conditions that are associated with the vehicle 136. Examples of these events and/or conditions include a reduction in tire pressure, activation of an engine maintenance signal, reduction in gas/petrol level below a threshold level, and GPS (global positioning system) related information. In the illustrative embodiment, the detected events and conditions are transmitted via some pre-established communication mechanism and/or service, generally illustrated as access networks 140, 150, to SIS 162. As an example, the vehicle 136 can be tracked by a dealer via an embedded tracking chip that communicates its data to the dealer via a wireless communication service (e.g., OnStar®). The server of that service can then be connected to the CDS 160 (under a support contract or other information sharing agreement) to provide this feedback of context information about the particular subscriber.

Thus, the ecosystem of the subscriber environment 110 can include a plurality of sources of user data, which are collectively referred to as context data and/or contextual data. This context data can be TV program metadata, location data, psychographic data on the user, and other user related data. Various different standards can exist that define the messaging protocols for communicating user information from the data sources to the SIS 162. The actual means of communication is not germane to the described embodiments, which focus more on how the received context data affects the selection of content provided to the subscriber device and whether additional correlative information should be transmitted with the selected context. In the described embodiments, the devices within the subscriber environment 110 or the access networks 140 can be programmed to continually providing context data to the SIS 162 or provide such data on some periodicity (e.g., twice a day) or only when an event or condition of interest is detected.

The second major section of CDS landscape 100 is generally illustrated as a cloud that represents one or a plurality of access networks 140. Access networks 140 represent an infrastructure that enables communication from subscriber environment 110 to CDS 160. Access networks 140 can include a plurality of physical components and services that enable and/or support communication of user information and context data from subscriber environment 110 to CDS 160. Rather than provide detail illustrations and/or listings of the various possible implementations of access networks 140, those services are generally presented via a communication cloud. The makeup of the access networks 140 is assumed to be expansive in nature, covering any technology required to enable the transmission of context information across the communication paradigm from subscriber environment 110 to CDS 160, without limitation. Additionally, access networks 140 can incorporate a direct content distribution medium 145, such as a fiber optic channel or co-axial cable connecting the subscriber devices 114 via home content gateway 115 at home location 112 with a content distribution mechanism 188 of CDS 160.

While not expressly illustrated in the figure, it is understood that the communication medium for a satellite service provider system (e.g., Dish Network) is over-the-air and thus no physical connection exists between the receiving device (Dish antenna) and the transmitting device (satellite). Similarly, aspects of the described embodiments can be implemented on a wireless subscriber device and/or computer system that connects to the CDS via a wireless connection to a transmission facility located outside of the subscriber's home location 112. Certain of the described features can also be applied to over-the-air basic television where the television receives programming content via some interface device (e.g., a high definition converter box) that can be individually targeted by the content provider. The description of the component makeup of CDS 160 will be provided with reference to both FIG. 1 and FIG. 2. FIG. 2 provides an example physical structure of a CDS 160, represented generally as a data processing system (DPS) 200 connected to other servers and networks. DPS 200 has hardware, firmware, and software components that enable the various functions described herein as generally being performed by CDS 160.

For simplicity, the component makeup of DPS 200 will be assumed to be synonymous with the component makeup of CDS 160, with the understanding that CDS 160 can use multiple different interconnected physical devices, which can be distributed across a network. In one embodiment, CDS 160 can be described as a server, although it is appreciated that the CDS can be a simple stand alone computer device for small scale content distribution or a multi-server system for larger scale processing and content distribution capabilities. As illustrated by FIG. 2, DPS 200 includes a plurality of functional components including at least one processor 205 and at least one memory 210 coupled to the at least one processor 205 via a system interconnect 215. Also connected to interconnect 215 are input/output (I/O) interface 225, a storage adapter 230, and network interface 240. I/O interface provides connectivity for one or more (singularly represented) I/O devices 227. Storage adapter 230 provides an interface for local storage 232 and, depending on implementation, for external content storage 238. For purposes of the present disclosure, both local storage 232 and external content storage 238 are assumed to include content storage facilities that store distributable content that can be forwarded to a subscriber device. System storage 232 has local content storage 236 and SIS database (DB) 168 within which subscriber content mapping table 234 is maintained. Local content storage 236 can include both regular content as well as specific content, such as advertising content. External storage 238 can be connected to DPS 200 via direct connection (indicated with the dashed lines) or via a network connection through network interface 240. In one embodiment, this network connection also supports the connection to a remote database of context data collected per subscriber, i.e., the SIS database 168, when remotely stored.

As shown, network interface 240 enables DPS 200 to connect to an external network 245, from which access is provided to content server 250 and third party servers 255. External network 245 can be a local area network or a wide area network, such as the Internet 155. Examples of these third party servers that are accessible via the external network 245 can include servers of third party consumer tracking systems, DM server, an ISP server, and other servers of access networks 140 (FIG. 1). Content server 250 can provide access to external content storage 238, in one implementation.

DPS 200 further includes content distribution mechanism 188 and an information receiving interface generally provided by network interface 240. As illustrated by FIG. 1, content distribution mechanism 188 enables distribution of content to at least one subscriber device (e.g., SD1 114) within a corresponding subscriber environment 110 to which the CDS 160 is communicatively coupled. Content distribution mechanism 188 connects DPS 200 to a one or more transmission or communication mediums. As further shown by FIG. 1, content distribution mechanism 188 transmits content 186, via a transmission medium 145 to the at least one subscriber device 114. In one embodiment, content distribution mechanism 188 can also connect to external network 245 via an alternate communication interface 149.

Returning to FIG. 2, DPS 200 can also include an information receiving mechanism (not specifically shown) at which information and/or context data collected from a user and/or a user environment can be received for processing by SIS 162 of FIG. 1. It is appreciated that most, and potentially all, of the communication performed by DPS 200 can be supported by network interface 240, in one or more embodiments.

Those of ordinary skill in the art will appreciate that the hardware components and basic configuration depicted in FIG. 2 may vary. The illustrative components within DPS 200 are not intended to be exhaustive, but rather are representative to highlight essential components that are utilized to implement the present invention. For example, other devices/components may be used in addition to or in place of the hardware depicted. The depicted example is not meant to imply architectural or other limitations with respect to the presently described embodiments and/or the general invention.

In addition to the above presented hardware components and stored content and SIS DB 168, certain functional features of DPS 200 and by extension CDS 160 can be provide via one or more program modules located within memory 210, and which are executed on and/or by one or more processors of the at least one processor 205. Among the functional logic provided by the execution of these program modules are subscriber information service (SIS) 162, which is responsible for maintaining, storing, and updating information about the subscribers, subscriber devices, user(s) associated with the subscriber devices, as well as location information and contextual information about the subscriber device, subscriber, and/or the user(s). The functional software components within memory 210 include a general operating system (OS) 212 and SIS utility (or SIS logic) 262, which includes context receiving (CR) engine 164 and context mapping module 166. Also illustrated within memory are correlation engine 170, content selection mechanism 176, and subscriber device selection module 193. The specific functionality associated with each of these software and/or firmware components are described with specific reference to FIG. 1.

In the illustrative embodiment of FIG. 1, third party content providers 190 represent content providers that provide content to the service provider (of CDS 160), for ingestion and re-distribution by the service provider. As is also described herein, in certain embodiments, all content, including advertising content, can be maintained at or within CDS 160, and CDS landscape 100 may not require and/or include third party content providers 190. With specific reference to FIG. 2, in the embodiment where the normal broadcast content and specific content, such as advertising, are maintained within local content storage 236 or external content storage 238 as content of CDS 160 versus on a third party server, system memory can also include functional modules for implementing a Content server and an Ad server. When the corresponding functional module is executed on processor 205, DPS implements features of content server to provide broadcast as well as targeted content. DPS likewise implements the features of Ad server to provide broadcast as well as targeted Ads.

As provided by FIG. 1, SIS 162, which is implemented by execution of SIS utility 262 on processor 205 of DPS 200 to provide SIS logic, receives contextual information and/or context data from the one or more sensors and devices located within the subscriber environment 110 and/or from the user(s) of the subscriber device(s) 114. SIS 162 can be communicatively connected via access networks 140 to at least one sensor 120 that is located within the subscriber environment 110. SIS 162 receives, from the at least one sensor 120, information about the subscriber environment 110, including events, conditions, and activities occurring at the subscriber environment that are monitored and/or detected by the at least one sensor 120 or other devices. The contextual information described herein can include both user-provided contextual information and the environmental information received at the SIS 162 from the one or more sensors or other devices.

SIS 162 includes context mapping module 166, which can be defined as a sub-routine that performs certain context mapping functions, described below. In one embodiment, the context mapping module 166 of SIS 162 receives contextual information associated with one or more contexts related to one or more of a subscriber, an end user, and a corresponding subscriber environment (e.g., 110). Context mapping module 166 can associate the received contextual information to a corresponding subscriber device when no such association yet exists. SIS 162 has an associated subscriber information service (SIS) database 168, which is managed by the SIS 162 and in which is stored (i) identifying information associated with the subscriber device; and (ii) received contextual information related to the subscriber device and the corresponding subscriber environment. SIS 162, and specifically the CR engine 164 and context module 166, aggregates, within the associated SIS DB 168, most of the user and/or environment related data that is collected from or within the ecosystem of the user and/or the subscriber device.

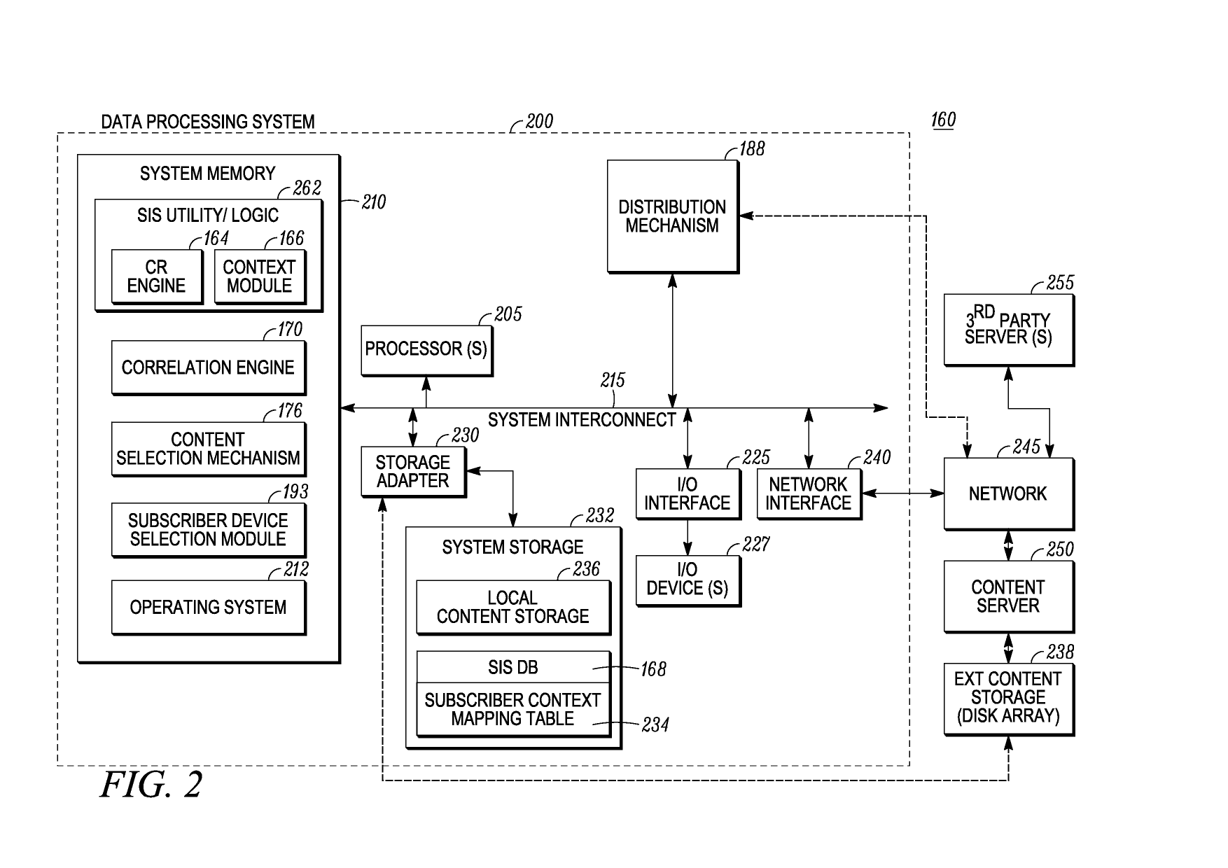

FIG. 3 illustrates an example table or data structure that can be maintained by SIS 162 and stored within SIS DB 168. Table 300 uses a series of columns, each representing, for a single subscriber device, a plurality of different data that are utilized to map the received information as contextual information with specific users of that subscriber device, specific content, and correlative information being provided to that subscriber device and/or that specific user. From left to right, the example columns of table 300 include subscriber ID 302, subscriber device ID 304, user ID 306, user account information 308, and user specific information and preferences 310 (e.g., user biographic data, such as sex and age, user preferences, such as types of content normally consumed by user). The user specific information and preferences 310 can correspond to any of a wide range of contextual data that is provided by the subscriber/user himself, either when initially registering to received content from the service provider or provided later when logged into the subscriber account.

Additional columns of table 300 include subscriber environment information 312, which may provide some general information about the subscriber environment that would be helpful when deciding whether to provide correlative information and what type of correlative information to provide. For example, the age of a subscriber's home can influence what type of insulation advertisement would be shown to a user. The next set of columns provide sensor detected information or context data 314 received from one or more sensors within the subscriber environment, and feedback response data 316 received from a user-provided feedback and/or sensed feedback that directly influences what weight is given to the contextual information when selecting content to transmit to the subscriber device.

A final set of columns then provides unique correlation ID 318 that is assigned to correlative information generated for that subscriber device, correlative information 320, which is generated and stored for distribution to that subscriber device along with specific content feedback, and specific content ID 322, identifying the specific content which is to be sent to the subscriber device along with the correlative information or unique correlation ID. It is appreciated that additional columns and/or different columns of information can be maintained within table 300, and that the presented columns are for illustrative purposes only. For example, other embodiments can provide for different columns indicating: whether correlation information should be submitted along with the specific content; and/or whether unique ID or some other affordance (e.g., icon) should be initially transmitted in lieu of the correlative information; and one or more columns providing an indication of a sensitivity, privacy, and/or urgency of the correlative information. As provide by table 300, for a single subscriber, one or more additional rows of the table can represent additional subscriber devices associated with the same subscriber and/or same subscriber environment.

As the various types of information are received at the SIS 162, the SIS 162 aggregates the information as contextual data associated with one or more of the subscriber ID, the one or more user IDs, the one or more subscriber devices, and one or more sensors that detect the events. This association is provided within SIS database 168 represented in FIG. 3 as table 300, which is stored in non-volatile storage. As provided by FIG. 1, the contextual data can be received from one or more sources. Additionally, with the described embodiments, the contextual data can include one or more of historical data compiled from monitored behavioral responses to previous targeted advertisement, user entered contextual data, user modification of existing contextual data, user demographics, user psychographics, association of specific types of end user devices and subscriber devices with a user, location information of one or more subscriber devices within the subscriber environment, types and characteristics of end user devices being utilized by a particular user, sensor detected behavior patterns of the one or more users, sensor detected user activities, location of a particular sensor within the ecosystem of sensors, and detected usage patterns of monitored electronic devices of one or more users. Other types of information can be aggregated and/or compiled to create the contextual data.

As further shown by FIG. 1, the one or more sources can include: the one or more subscriber devices; one or more other devices that enable access to the SIS 162 and entry of contextual data into the subscriber account maintained within the SIS database 168; one or more sensors within an ecosystem of sensors associated with one or more subscriber devices and/or users within the subscriber environment 110. In one embodiment, the SIS 162 granularly associates specific components of the contextual data with specific user IDs within the subscriber account by linking one or more user IDs to one or more of: specific types of events that are being monitored within the environment; specific content that is most likely viewed by each of the respective one or more user IDs; and a particular one of the subscriber devices that is being utilized by the respective one or more users. After the association is complete, the SIS stores the mapping within table 300, which association is then accessed during a later scheduling of the specific content to determine whether to include the correlative information with the specific content.

Returning to FIG. 1, in addition to SIS 162, CDS 160 also has content selection mechanism 176 that receives an input of contextual information 174 derived from the information received at CR engine 164 and evaluated and mapped by context mapping module 166. Responsive to receipt of the contextual information from the context mapping module 166 and/or based on the received contextual information, the content selection mechanism 176 selects at least one specific content 180 to provide to the corresponding subscriber device 114. Selection of the specific content 180 can be from one of a plurality of available servers of third party content providers 190, where, in certain embodiments, the servers can be separated into content servers 198 of regular content providers and Ad servers 199 of advertisement content providers. It is appreciated that the advertisement content can be stored within a same physical server as regular content, and the separation of the servers within FIG. 1 is only intended to illustrate that the advertising content is different from the regular content.

Additionally, advertising content represents only one specific implementation of the described embodiments, as the specific content requested can be normal program content, in one or more embodiments. Content selection mechanism 176 forwards a request 178 for specific content or content type to the third party content providers 190, which respond by providing the specific content 180. In one alternate embodiment, specific content 180 can also be retrieved from a locally maintained content storage database or a content server that is affiliated with or a part of CDS 160, rather than from a third party content provider 190. The content selection mechanism 176 can then search from among the available content to select the specific content based on the received and analyzed contextual information.

After the specific content 180 is identified and received by content selection mechanism 176, content selection mechanism 176 inserts the specific content into a content stream 186 (represented as the vertical arrow) of regular/normal program content 184 being transmitted to the corresponding subscriber device(s) 114, and the content stream 186 is automatically forwarded with the specific content 180 inserted therein to content distribution mechanism 188.

In addition to the program modules providing the functional logic for SIS 162 and content selection mechanism 176, other executable program modules within DPS 200 enable the functional logic for correlation engine 170. In one embodiment, correlation engine 170 correlates the received contextual information with specific types of content and forwards a trigger 172 to content selection mechanism 176 to cause content selection mechanism to request 178 and/or select specific content 180. Correlation engine 170 also generates one or more of (1) correlative information 182 explaining why the specific content is being presented and (2) a selectable affordance 183 or some other identifying construct that is indicative of the presence of correlative information. Finally, correlation engine 170 forwards to the content selection mechanism 176 (or directly to content distribution mechanism 188 in an alternate embodiment) the generated correlative information 182 or the selectable affordance 183. The content selection mechanism 176 then inserts into the content stream 186 the received correlative information 182 or the selectable affordance 183 by which access to the correlative information can be retrieved. This correlative information 182 is illustrated as a separate block provided in addition to the specific content 180 on the content stream 186; However, it is appreciated that, in one or more implementations, the correlative information 182 can be embedded within or inserted on top of the specific content 180 and is transmitted concurrently with and/or as a part of the specific content 180.

In one embodiment and as provided in FIG. 1, the correlation engine 170 determines, by analyzing the contextual information received, whether correlative information should be transmitted along with the specific content 180. In response to determining that the correlative information should be transmitted, the correlation engine 170 generates the correlative information 182 and forwards the correlative information 182 to the content selection mechanism 176 (or content distribution mechanism 188, in an alternate embodiment) for transmission along with the specific content 180. The correlation engine 170 can, in some embodiments, also issue a trigger (e.g., a yes/no signal) 172 to content selection mechanism 176 to alert content selection mechanism 176 that specific content 180 is to be selected. In one embodiment, the trigger 172 can also indicate whether correlative information and/or an affordance is to be transmitted along with the specific content. Additionally, the correlation engine 170 determines when to forward a selectable affordance 183 in lieu of the correlative information 182. In response to the correlation engine 170 determining that a selectable affordance should be forwarded, the correlation engine 170 generates the selectable affordance and forwards the selectable affordance 183 to the content selection mechanism 176 or content distribution mechanism 188 in place of the correlative information 182. The correlative information is mapped to the subscriber device and the selectable affordance within at least one of the correlation engine 170 and SIS 162.

After the content stream 186 with inserted specific content 180 and correlative information 182 is received at the content distribution mechanism 188, the content distribution mechanism 188 transmits the entire content stream 186 including the specific content 180 and correlative information 182 to the subscriber device 114 (e.g., using the access network 140).

Content distribution mechanism 188 can incorporate certain programmable functions, including a subscriber device selector module 195 by which the content distribution mechanism 188 can select a specific one of multiple subscriber devices located within the single subscriber environment to which to forward the specific content 180 and/or the correlative information 182. Also illustrated within content distribution mechanism 188 is an alternate communication interface 194, which couples to a secondary communication medium 149. In one embodiment, correlative information 182 can be separately communicated to a subscriber over the secondary communication medium 149 rather than being communicated as a part of the content stream 186. This alternate embodiment enables secure and/or confidential transmission of the correlative information to a subscriber's cell phone, for example, rather than displaying or outputting sensitive or important or urgent correlative information over an output device (e.g., television) generally located at the subscriber's home location 112.

According to one embodiment, following the transmission of the specific content and/or correlative information, the context mapping module 166 of the SIS 162 monitors for receipt of updated contextual information related to one or more of the selection of the specific content and the transmission of the correlative information. Then, in response to (i) the updated contextual information being received within a pre-established time period following transmission of the specific content and (ii) the updated contextual information indicating an expected response to a receipt by an end user within the monitored environment of the specific content, the context mapping module 166 updates a context mapping within the SIS database to confirm a recent successful correlation between two or more of: (1) the received contextual information, (2) the specific content, and (3) the correlative information with the particular subscriber device. The context mapping module 166 then modifies a schedule for inserting the specific content into the content stream, based on the updated correlation. Thus, for example, where the correlative information and specific content were selected in response to detection of a low tire pressure on the subscriber's vehicle, receipt of (1) a sensed response that indicates the car tire pressure is no longer low or (2) a user-provided response that the user has received the message and will respond accordingly, would cause (a) the correlation engine to remove the correlative information from the content stream being sent to the subscriber device and/or (b) the content selection mechanism to stop inserting the specific content into the content stream.

According to one embodiment, in response to at least one of (i) not receiving any updated contextual information within the pre-established time period following initial transmission of the specific content or (ii) receiving updated contextual information that does not indicate the expected response, the context module reduces a level of association within the SIS database between (a) the received contextual information, (b) the specific content, and (c) the correlative information with the particular subscriber device. The context module 166 detects receipt of a negative feedback response to the correlative information. This negative feedback response indicates that a user of the subscriber device does not want to receive at least one of the specific content and the correlative information. In response to detecting receipt of the negative feedback response, the context module 166 suspends an insertion into the content stream of at least one of the specific content and the correlative information.

Additionally, in one embodiment, the context module 166 further determines at least one of a priority level, a seriousness level, a sensitivity level, and an urgency level associated with the received information; and modifies one or more parameters forwarded to the content selection mechanism 176 and to the correlation engine 170 to trigger a selection of at least one of the specific content 180, the correlative information 182, and a presentation type (i.e., actual information versus selectable affordance) of the correlative information to the subscriber device, based on one or more of the priority level, the seriousness level, the sensitivity level, and the urgency level.

In embodiments where the specific content 180 includes video content for display on an end user output device, such as TV 116, the selectable affordance 183 can be presented as an icon that is displayed along with specific content on the end user output device. The correlation engine 170 encodes the icon to output and/or visually present one or more display characteristics, such as a bright color or a flashing symbol or a message of “select to view”. These display characteristics correspond to one or more characteristics associated with at least one of the received contextual information, the specific content, and the correlative information. The correlative engine 170 encodes the icon to enable the correlative information 182 to be displayed along with the specific content 180 following receipt by the content distribution mechanism 188 of a selection of the icon via feedback medium 147. In one embodiment, the selection of the icon triggers a prompt for entry of a required security credential, and the correlative information 182 is not displayed unless the required security credentials are provided at the subscriber device and sent back to the content distribution system 160 via the feedback medium 147. Responsive to receipt by the correlation engine 170 of a feedback signal (which is transmitted from the subscriber, received at the content distribution mechanism 188, and passed down to the correlation engine 170) that indicates that the selectable affordance was selected at the subscriber device, the correlation engine 170 forwards the correlative information to the content distribution mechanism 188 for transmission to the subscriber device 114.

In a first alternate embodiment, the correlative information can be passed to the content distribution mechanism 188 at the same time as the selectable affordance. The content distribution mechanism 188 then transmits only the selectable affordance and holds the correlative information while waiting for feedback from the subscriber device. After the content distribution mechanism 188 receives the required feedback from the subscriber device, the content distribution mechanism 188 forwards the correlative information to the subscriber device, without requiring any further communication with the correlation engine 170. In a second alternate embodiment, the correlative information can be forwarded to the subscriber device along with the selectable affordance. However, the subscriber device includes the intelligence to only provide the selectable affordance to the user until the user enters the appropriate selections at the subscriber device. After the appropriate selections and/or entries are made at the subscriber device, the selectable affordance is replaced with the correlative information, without having to transfer information back to the CDS 160 from the subscriber device. This alternate embodiment allows for almost instantaneous replacement of the affordance, as the subscriber device already contains the correlative information.

Also, in one embodiment, the context mapping module 166 generates a unique correlation identifier (ID) (see 318, FIG. 3) for the received contextual information and stores the unique correlation ID in the SIS database 168. The unique correlation ID is forwarded to the correlative engine 170, which tags the correlative information with the unique correlation ID. The content distribution mechanism 188 then transmits the unique correlation ID to the subscriber device 114. The unique correlation ID can be transmitted via one or more transmission mediums from among: a first transmission medium (content distribution medium 145) by which the specific content is transmitted to the subscriber device and a second, different transmission medium 149. In response to receiving feedback (or feedback responses) 147 indicating a query of the unique correlation ID at the subscriber device 114, the correlative engine 170 retrieves the specific correlative information using the unique correlation ID and forwards the specific correlative information 182 to the content distribution mechanism 188 to transmit the correlative information along with the specific content 180 for output at the subscriber device 114.

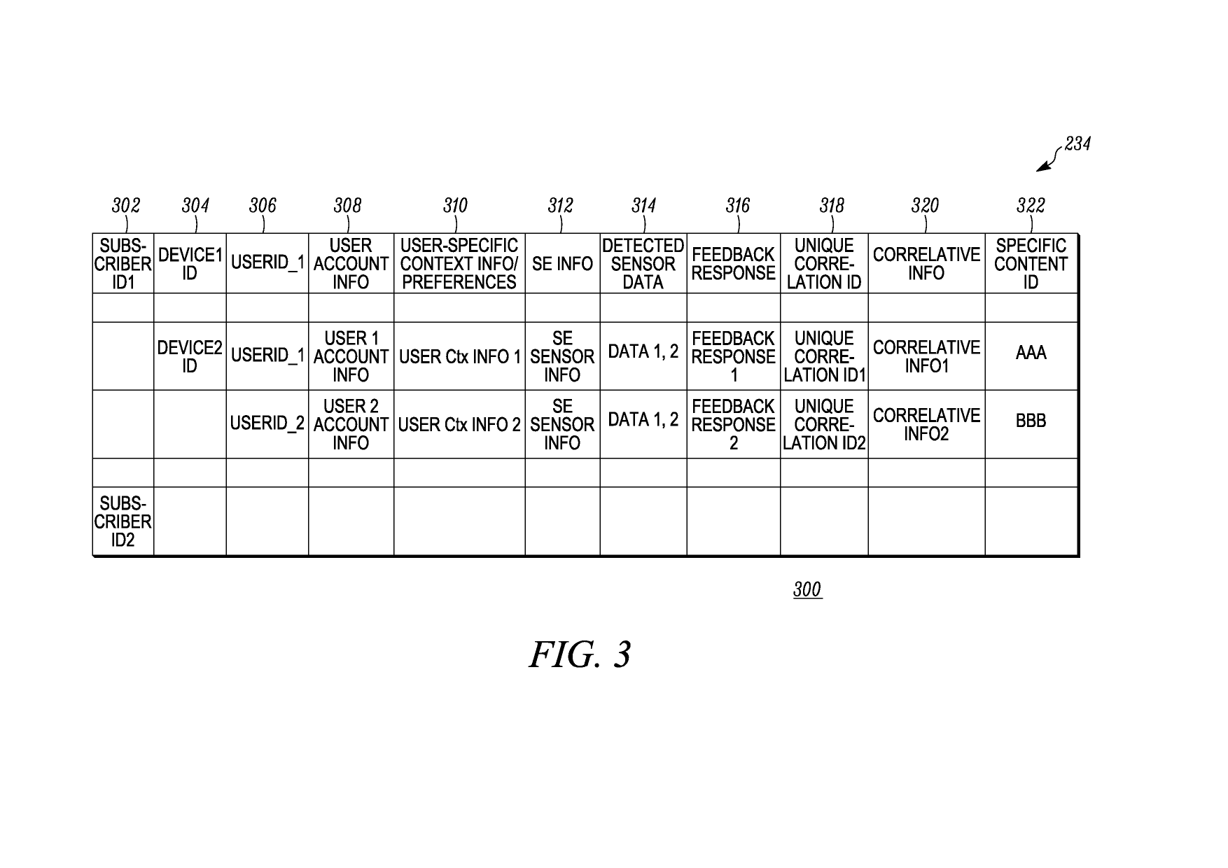

In one or more embodiments, the subscriber device is a STB that provides content to a connected television set. Thus, from a STB box perspective, aspects of the disclosure add reference data to the subscriber information service data that will eventually allow the STB to correlate the targeted advertising with the metadata or event that resulted in that particular advertisement being selected and displayed on the connected television set. FIG. 4 is a block diagram representation of functional components of a STB 400 being utilized as one type of subscriber device. STB 400 includes a processing component 405, a memory 410, a non-volatile storage 415, and interface components 425 (e.g., HDMI) for connecting to an end user output device, such as TV 416 or 116 (FIG. 1). STB 400 further includes a transceiver port 420 at which STB 400 communicatively connects to a content distribution service provider 460, such as CDS 160 (FIGS. 1 and 2).

STB 400 includes a wireless I/O interface 427 through which a user can communicate with STB 400 via a remote control 118 or other supported I/O device. In one embodiment, the I/O capabilities can also be provided via an alphanumeric keypad 440 of STB 400. Certain aspects of the described embodiments involve the receipt by the SIS 162 of feedback responses from the subscriber device, entered by the subscriber and/or user. Supporting these and other functions of STB 400 are programmable logic, including operating firmware 430 and feedback response utility 435, which can be a firmware upgrade to operating firmware 430, in one embodiment. Feedback response utility 435 enables the prompting for and receipt of certain feedback responses to the display of specific content and/or associated correlative information. These feedback responses 147 (FIG. 1) can be communicated to SIS 162 directly from STB 400 via transceiver port 420, following receipt of input at STB 400 while (or after) the specific content and/or the correlative information is being outputted. Alternatively, the feedback responses can be communicated to SIS 162 via a different method, such as by user entry of the response on a website of the CDS 160 while the user is logged into the subscriber account.

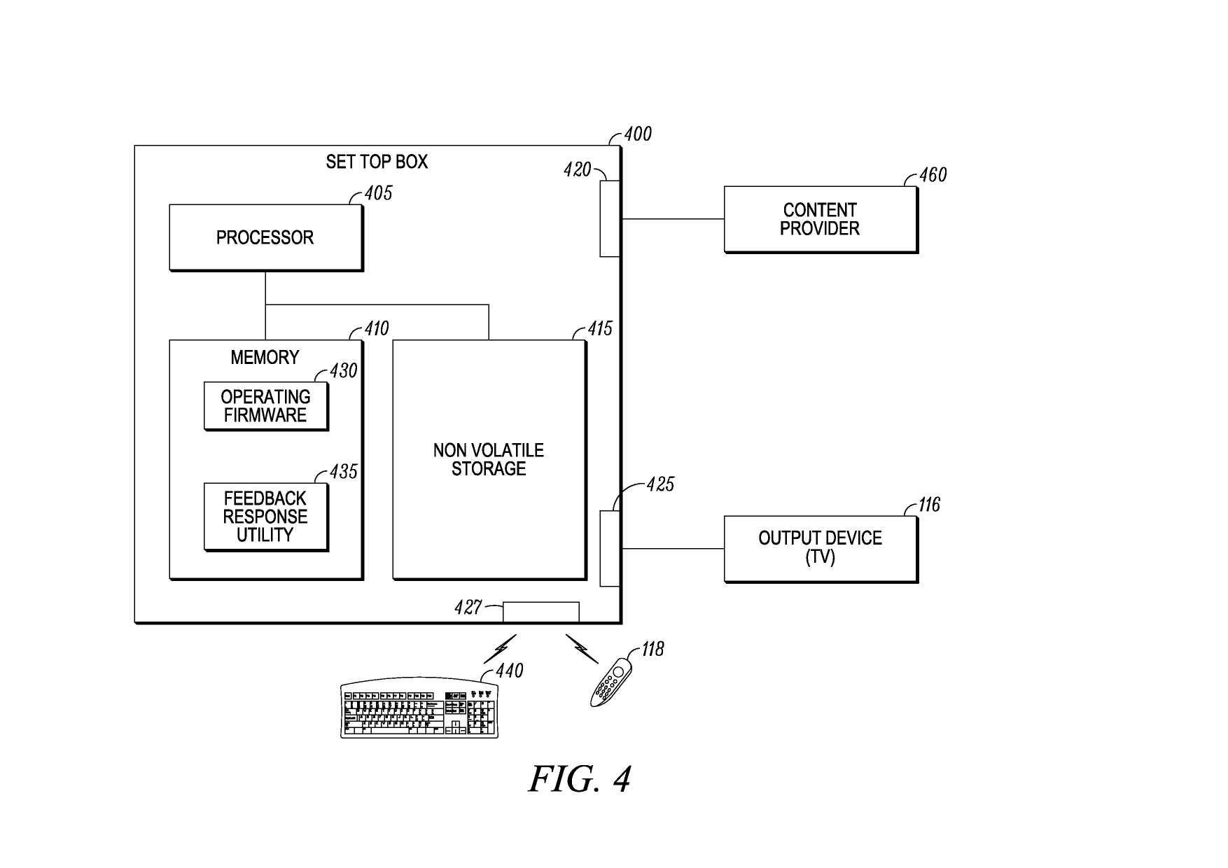

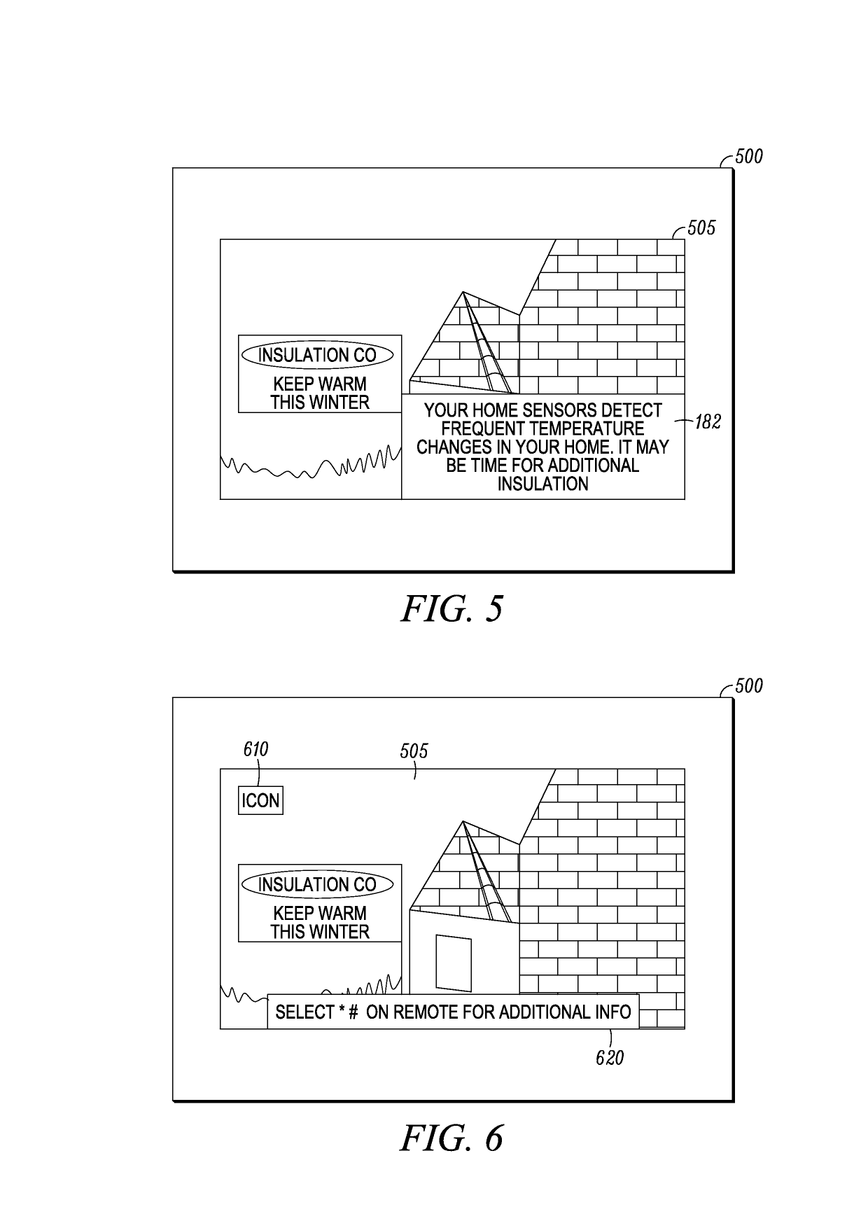

Referring now to FIGS. 5 and 6, there are illustrated two different representations of an example display screen 500, such as a television screen, of an end user output device, on which is displayed an output of specific video content 505 along with visible correlative information and/or a selectable affordance. In the described embodiment, the displayed video content 505 is assumed to be the specific content 180 that is selected based on the contextual information received about the subscriber and/or subscriber environment. In the illustrative example, both the specific content 180 (specific video content 505) and the correlative information 182 are visually represented on the end user video output device (e.g., TV 116 of FIG. 1). The correlative information 182 of FIG. 5 is shown as visible information because the correlative information 182 is visibly displayed for viewing on the display screen 500. It is appreciated that in some embodiments, as illustrated by FIG. 6, the correlative information can be hidden, and/or can be presented as an icon 610 or other selectable affordance 183, such as a unique correlation ID (318, FIG. 3). These particular embodiments are partly illustrated by FIG. 6. In the case of correlative information that is simply hidden by default or based on a particular user setting of the STB, the presence of the correlative information is indicated by a visible notification or prompt 620, and entry of a particular code sequence or entry of a particular query or function button on the remote control or directly the STB can make the correlative information 182 visible. Likewise, for instances in which an icon 610 or other visible affordance is initially presented in place of the actual correlative information, selection of the icon and/or other visible affordance can, in some embodiments, cause the correlative information to be retrieved and displayed on the display screen 500. For more complex scenarios, a particular code sequence or password may be required before the correlative information is presented, and a prompt 620 is generated on the display screen 600 requesting that the correct code sequence or password be entered to receive the correlative information. Other aspects of this security feature are provided within the description of the flow charts below. Additionally, while presented as visually outputted correlative information, the correlative information 182 can be audible rather than visible, in alternate embodiments.

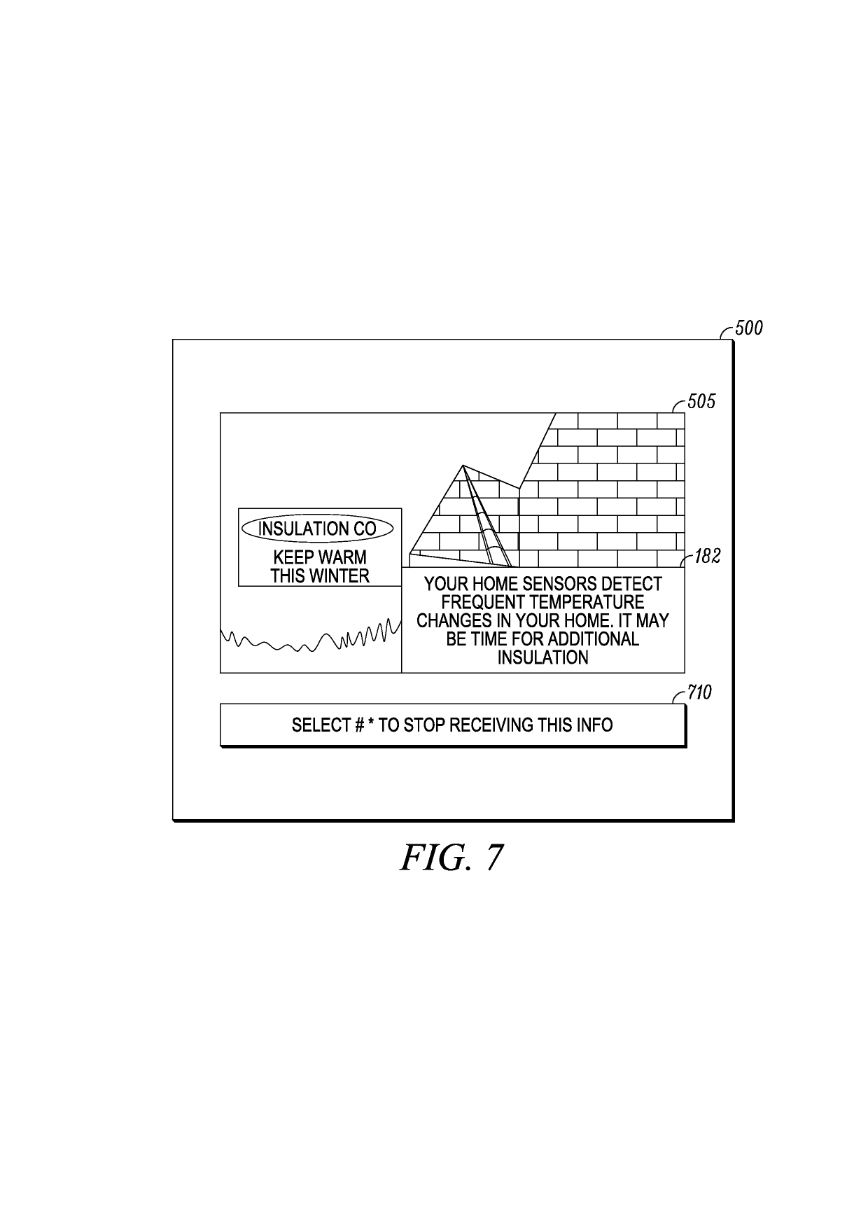

FIG. 7 illustrates an example of an embodiment in which a prompt 710 is generated on display screen 500 to provide the user of the subscriber device an opportunity to communicate if the user would prefer to stop receiving the particular specific content, based on detected and/or received content, and/or to stop receiving the correlative information. With this embodiment, the user can then enter the required entry to provide a negative feedback response to the display of the specific content and/or the correlative information. This embodiment finds particular application within the implementation in which the user is aware of the monitoring being performed within the subscriber environment. Thus, according to one embodiment, access to the features described herein can be a subscribed-to service that requires a subscriber to agree to receive correlative information and to indicate whether such correlative information should require a password entry before it is displayed to the use of the subscriber device. Additionally, certain other privacy considerations can be agreed to or established by the subscriber. For example, the subscriber can select which user portable devices can be monitored and/or tracked for contextual information, or the user can define what is considered the subscriber environment for detection and recording of contextual information. Thus, while a user's vehicle can be included in the subscriber environment, the user can exclude his office from the monitored subscriber environment even if the user's laptop is utilized in that physical location.

A specific example of the application of the above features of the disclosure can be provided with reference to the above display screens of FIGS. 5-7 and components of FIG. 1. With the subscriber devices located within subscriber environment 110 (FIG. 1), one or more of the sensors 120 are temperature monitoring devices, such as a thermostat associated with the air conditioning and heating unit within the home location 112. A home monitoring system may detect temperature fluctuations in the home environment, which fluctuations may or may not be detected (or detectable) by the user(s) in the home. The home monitoring system is communicatively connected to SIS 162 (via one or more access networks 140) to make this temperature fluctuation data available to one or more service providers and/or advertisers, and specifically the CDS 160. This information is converted into contextual data that is used to trigger the content selection mechanism 176 to retrieve specific targeted advertising that addresses the detected temperature fluctuations. In this example, the specific targeted advertising includes an advertisement about home insulation from an insulation company, Insulation Co. The user of the subscriber device within the home location 112 is thus presented with advertisements (advertising content 505) for home insulation on his television.

However, because the temperature fluctuation can be such that the user viewing the advertisement for home insulation does not appreciate or understand the connection between the advertisement and the detected temperature fluctuations, the correlative information 182 provides additional information that explains to the user why the home insulation advertisement is being presented to the user. The user can then elect to modify the context of the advertisement by providing feedback response 147 indicating that the user does not wish to receive such advertisement in the future, perhaps because the particular use has no control of or makes no decisions regarding insulation in the home location. In one embodiment, as described in the multi-user implementation below, the correlation engine can attempt to identify another user in the subscriber environment for whom the information will be considered pertinent and/or important.

As another example, a tire tread detection system of the user's vehicle can provide data that indicates to the SIS 162 that the tread level of one of the vehicle's tire is getting a little low. The advertising content selected can then be for new tires. However, the user of the subscriber device may not see the targeted advertisement or may simply ignore the advertisement as not relevant because he is not the driver of the vehicle. Also, simply showing tire commercials to this particular user may not be effective, because of user's lack of knowledge and/or memory of the context of the problem with the tires on his vehicle. However, by providing the correlative information along with the targeted advertisement, the user of the subscriber device is provided specific information correlating the detected events to the targeted advertisements, within certain contexts, increasing the effectiveness of the targeted advertisement.

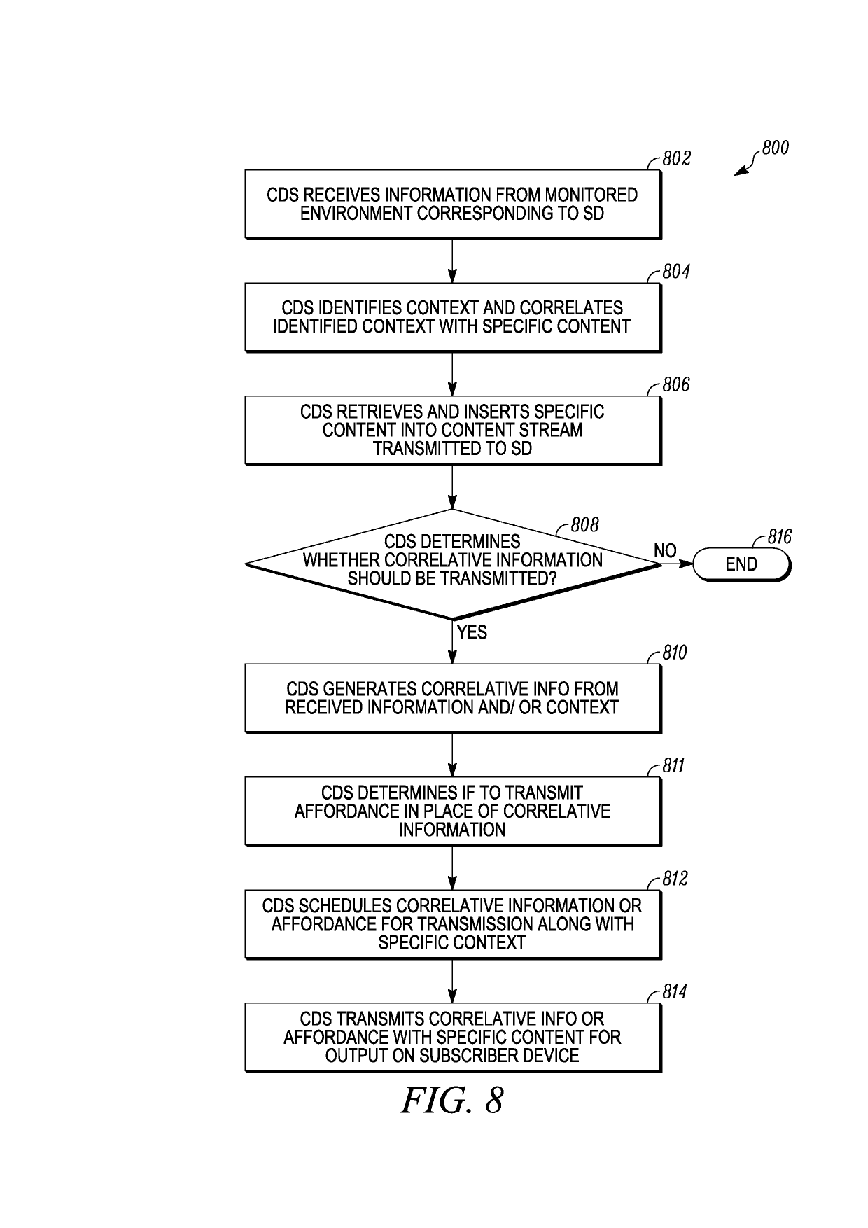

The flow charts of FIGS. 8, 9, 10, and 11 illustrate various aspects of the methods by which the above processes of the illustrative embodiments are completed. Although the methods illustrated in FIGS. 8-11 may be described with reference to components and functionality illustrated by and described in reference to FIGS. 1-6, it should be understood that this is merely for convenience and alternative components and/or configurations thereof can be employed when implementing the various methods. Certain portions of the methods can be completed by program modules corresponding to SIS 162, correlative engine 170, content selection mechanism 176, and/or content distribution mechanism 188 executing on one or more processors (e.g., CPU 205) within a server data processing system (DPS 200). For simplicity in describing the methods, all method processes are generally described from the perspective of a general CDS 160 (FIGS. 1 and 2).

FIG. 8 illustrates certain aspects of a method for selectively distributing content from a backend CDS 160 to at least one subscriber device 114. The method 800 begins at block 802 with CDS 160 receiving information about a context from a monitored environment corresponding to the subscriber device 114. The received information includes at least one of (a) sensor information received from a sensor located within the monitored environment, (b) detected subscriber behavior captured by the subscriber device, or (c) subscriber provided context information. The method 800 then includes CDS 160 identifying the context and correlating, using a processor of the backend CDS, the context identified by the received information to one or more specific content (block 804). Following the correlating, the method 800 includes CDS 160 inserting the specific content into a content stream being transmitted to the subscriber device (block 806). In one embodiment, the method includes CDS 160: determining, by analyzing historical data, a type of content that is regularly consumed via the subscriber device; and inserting the specific content into one or more slots available during transmission of that type of content within the content stream to the subscriber device.

Returning to the flow chart, the method 800 includes CDS 160 determining whether correlative information should be transmitted along with the specific content (decision block 808). The method ends at block 816 if no correlative information is transmitted. In response to determining that the correlative information should be transmitted, the method 800 includes CDS 160 generating the correlative information (block 810) and determining whether to transmit a selectable affordance in place of the correlative information (block 811). The method 800 then includes CDS 160 scheduling the correlative information or the affordance to be transmitted along with the specific content (block 812). Finally, the method includes CDS 160 transmitting, along with the specific content, at least one of (a) correlative information explaining a context surrounding why the specific content is being presented and (b) a selectable affordance by which access to the correlative information is provided (block 814).

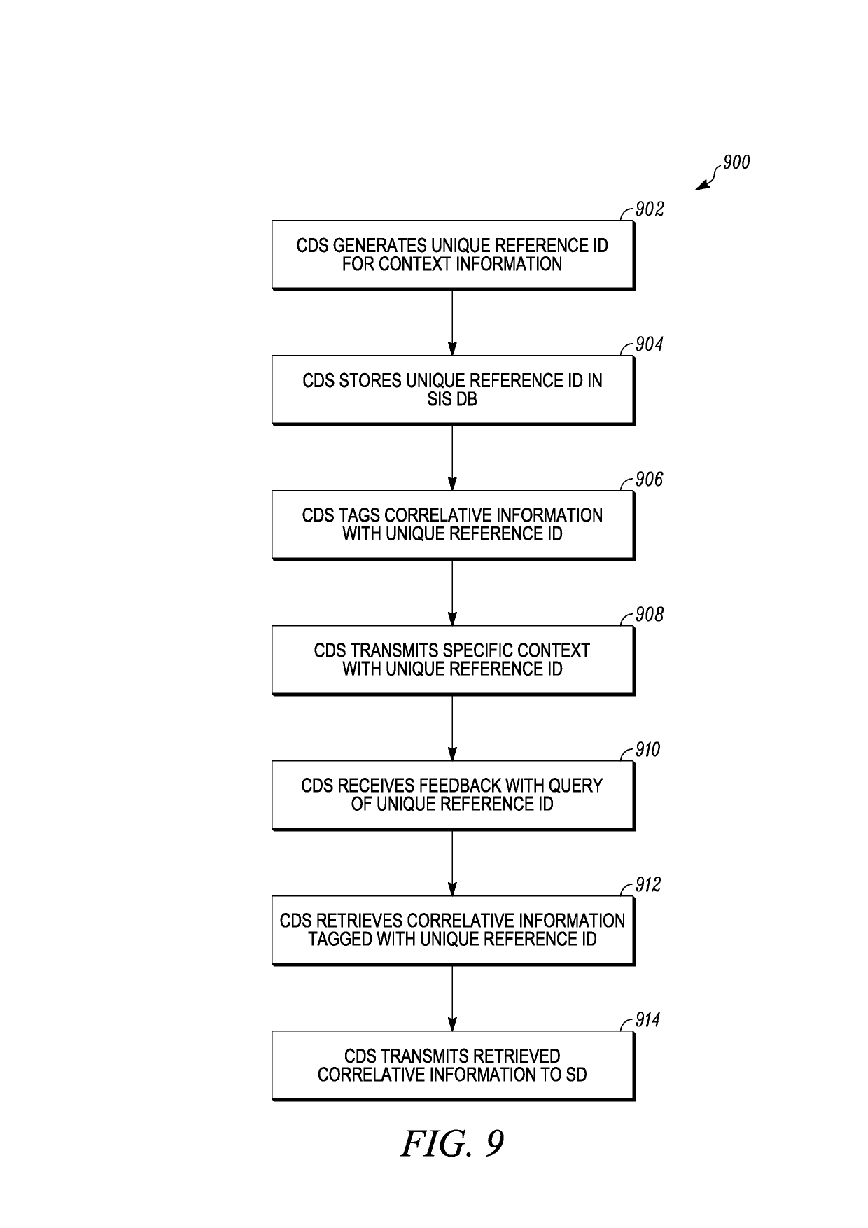

FIG. 9 provides a method 900 for establishing a unique correlation identifier (ID) of correlative information that is then utilized to control access to the correlative information. With this implementation, CDS 160 initially forwards the unique correlation ID as a selectable affordance, in place of forwarding the actual correlative information. Beginning at block 902, CDS 160 generates a unique correlation identifier (ID) (e.g., data value stored at 318, FIG. 3) for the received context information, and CDS 160 stores the unique correlation ID 318 in a database, such as the SIS DB 168 (block 904). CDS 160 tags the correlative information with the unique correlation ID 318 (block 906) and transmits the unique reference ID along with the specific content (block 908). Depending on the specific implementation, the unique reference ID can be transmitted via one or more transmission mediums from among: a first transmission medium by which the content stream is transmitted to the subscriber device and a second, different transmission medium, such as the Internet. Then, in response to receiving feedback indicating a query of the unique reference ID at the subscriber device (block 910), CDS 160 retrieves the correlative information 320 from the database 300 using the unique reference ID (block 912), and CDS 160 transmits the correlative information to be outputted at the subscriber device, along with or following the specific content (block 914).

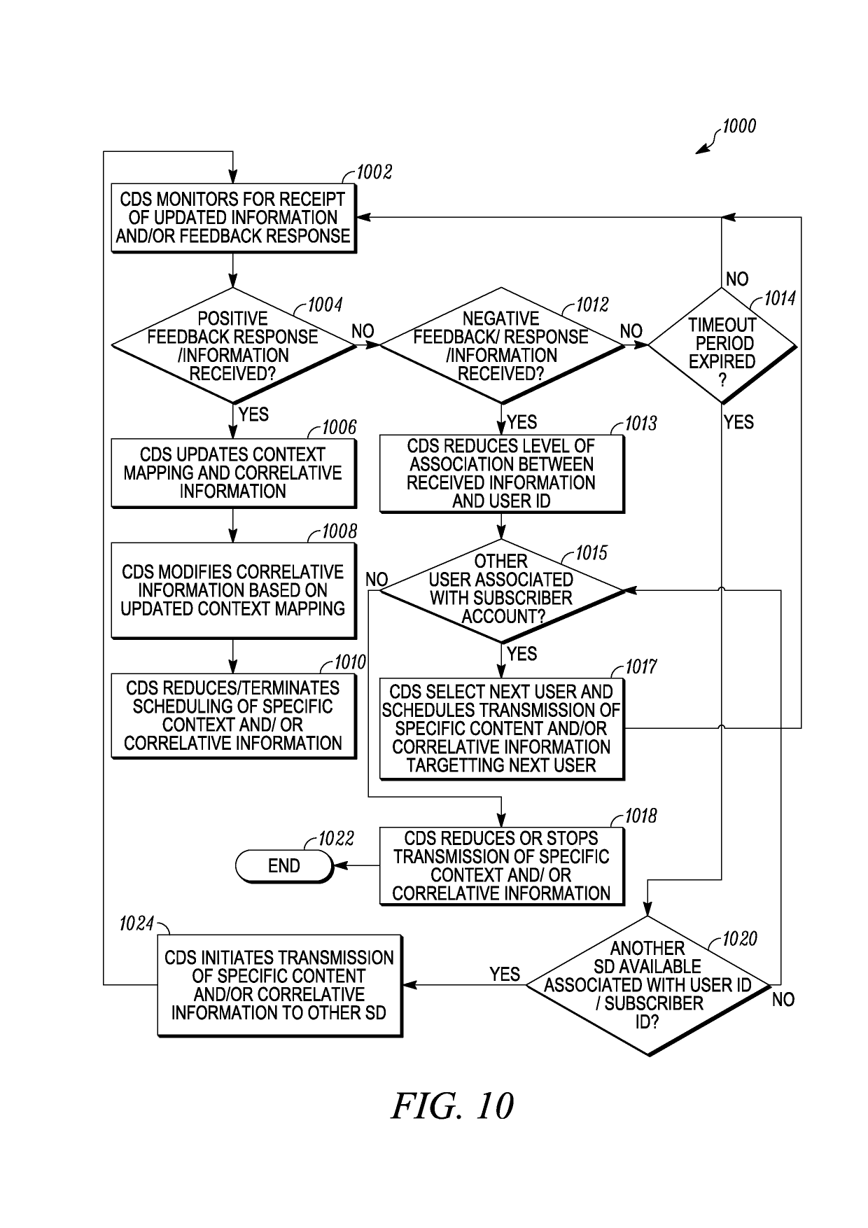

FIG. 10 illustrates aspects of the method 1000 by which CDS 160 updates context mapping that affects a correlation of content and correlative information with the subscriber device and/or user, based on received feedback information. Beginning at block 1002, the method 1000 provides CDS 160 monitoring for receipt of updated information, including feedback response. The updated information indicates one or more of (a) a change in the at least one context subsequent to initiating transmission of the specific content and (b) a user entry of a modification to relevant contextual data or (c) user feedback or responsive action. It is appreciated that the updated information and/or feedback response can either be positive or negative with respect to the existing correlation. If, as determined at block 1004, positive updated information and/or feedback response is received, the method 1000 includes CDS 160 updating a context mapping to confirm a recent successful correlation between at least one of (a) the received information, (b) the specific content, and (c) the correlative information, with the particular subscriber device and/or user ID (block 1006).

Also, in one implementation, in response to receiving a positive feedback response to the correlative information, the method 1000 includes CDS 160 updating and/or modifying the correlative information based on the positive feedback response (block 1008). Further, in response to receiving updated sensor information that is indicative of a positive response provided in response to receipt at the subscriber device of at least one of the specific content and the correlative information, the method 1000 includes CDS 160 reducing or terminating a schedule for inserting the specific content and/or the correlative information into the content stream (block 1010). In one embodiment, the reduced schedule can be a normal schedule.

When positive feedback information or response is not received at decision block 1004, CDS 160 determines at decision block 1012 whether negative feedback information or response has been received. In response to not receiving negative feedback information or response, CDS 160 checks at block 1014 whether a pre-established timeout period has expired. CDS 160 continues to monitor for receipt of updated information and/or a feedback response when the timeout period has not expired. In one embodiment, CDS 160 continues to monitor until at least one of (i) not receiving any updated information or feedback response within the pre-established timeout period following initial transmission of the specific content or (ii) receiving updated information that does not indicate an expected response, i.e., receiving negative information.

In response to receiving negative feedback information at block 1012, the CDS 160 reduces a level of association between the received context information and the recently targeted user ID (block 1013). Then, the method provides CDS 160 checking at decision block 1015 whether there are other users associated with the subscriber account that can be targeted to receive the specific content and correlative information. When there is another user available, CDS 160 selects the next user and schedules a transmission of the specific content and correlative information to target that next user (block 1017). In one specific embodiment, receipt of a negative feedback response to the correlative information indicates that a user of the subscriber device does not want to receive at least one of the specific content and the correlative information. The method 1000 can then also include CDS 160 reducing, suspending, or stopping the transmission of the specific content to the subscriber device and/or to the specific user (block 1018) when no other user is associated with the subscriber account (block 1015, NO branch). Specifically, CDS 160 suspends an insertion into the content stream of at least one of the specific content and the correlative information. The method then ends at block 1022.

Also, in one embodiment, multiple subscriber devices can be connected to a single subscriber account, with each device being separately addressable from the CDS 160. Then, in response to expiration of the timeout period (as determined at block 1014) without receiving any positive or negative feedback or response, the method includes the CDS 160 determining if there is another subscriber device within the monitored subscriber environment that has some association with the user being targeted (block 1020). Responsive to there being another subscriber device within the subscriber environment, the method includes CDS 160 initiating a transmission of the specific content and the correlative information to the other subscriber device (block 1024) and then re-initiating monitoring for receipt of updated information and feedback response (block 1002). If there are no additional subscriber devices, then the method returns to block 1015 to determine if there is another user available.

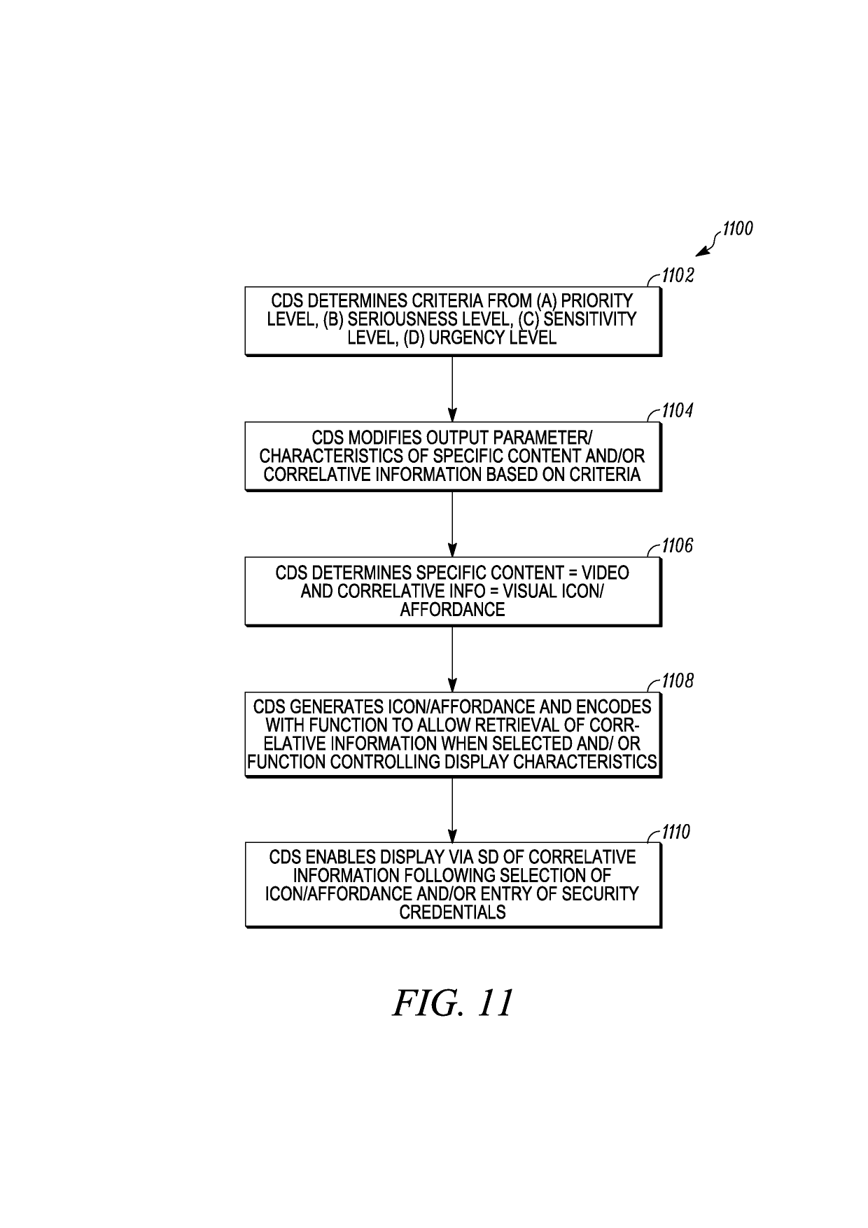

FIG. 11 illustrates a method 1100 for completing various other aspects of the described embodiments. The method begins at block 1102 at which CDS 160 determines at least one of a priority level, a seriousness level, a sensitivity level, and an urgency level associated with the received sensor/environment information. CDS 160 then modifies one or more output parameters, including a display parameter or scheduling, for example, of at least one of (a) the specific content and (b) the correlative information based on one or more of the priority level, the seriousness level, the sensitivity level, and the urgency level (block 1104). At block 1106, CDS 160 determines that the specific content includes video content for display on an end user device and that CDS 160 should provide an icon or other selectable affordance in place of the correlative information on the end user device. CDS 160 generates the icon or affordance and encodes the icon or affordance to (a) allow retrieval of correlative information when selected and/or (b) present one or more particular display characteristics (block 1108). The particular display characteristics can correspond to one or more characteristics associated with at least one of the received information, the specific content, and the correlative information. For example, the display characteristics can be a blinking alert for matters that are of some urgency, or a larger font size for an important matter, or a passcode prompt for a secure or sensitive matter. CDS 160 then enables the correlative information to be displayed along with the specific content following receipt of a selection of the icon and entry of any required security credentials at the subscriber device (block 1110). In this implementation, the icon is specifically encoded so that the correlative information cannot be displayed unless the required security credentials are provided at the subscriber device. Also, in one embodiment, the icon is encoded such that selection of the icon on a display of the end user device causes the icon to transform into a visual depiction of the correlative information on the display.

Aspects of the disclosure enable the presentation of content and/or correlative information at the subscriber device to be context aware. In one embodiment, the subscriber device (e.g., STB) can have provisions for defining the contextual reference that governs the displaying of the correlative information during advertisements. For example, there may be health or financial related targeted advertisements that a user may not want any correlative data associated with. One embodiment provides a secondary level of analysis of context data that is sensitive to the context of the events that resulted in the targeted advertisements being selected and that provides information to the user that would be productive to the user. For example, the secondary analysis may identify events that are classified under one or more of the following context: (1) Events that are not easily detectable/known by the user (e.g., temperature fluctuations in the home, water detection in low traffic area of the basement, utilization of a phone in a manner that would increase billing); (2) Events that have been ignored by the user for a specified period of time (e.g., tire tread levels falling below a certain threshold for more than 60 days); and (3) Serious events that could result in injury or damage to the home (e.g., vehicle tire punctured by nail, ice dam buildup on roof). Detection of the presence of one or more of these conditions can then be utilized to determine whether the targeted advertisement should be supplemented with correlative information. In an alternate embodiment, the context of the display device may determine whether correlative information is provided along with targeted advertising. For example, if the user is watching content on the user's phone or tablet PC, then the device is much more of a private device that may allow for the display of more personal/private correlative information with the targeted advertising, and the display of this personal/private information may not be as desirable as when the device is a television screen located in a family room.

In each of the flow charts above, one or more of the methods may be embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

The above described embodiments have been presented at a subscriber device granularity and with general selection of specific content. In the below examples of extended embodiments, the specific content is targeted advertising and the correlative information is information that explains why the particular targeted advertising is being displayed on a particular subscriber device and/or to a particular user. Aspects of the correlation of context with content selection and distribution are also described on a user level, with each user having a unique user ID that is associated with a particular subscriber device. In this implementation, the SIS 162 can maintain contextual policies for sharing correlative data at a user level, and SIS 162 would enforce these policies on a per-user basis. In a related embodiment, the subscriber device can be programmed to maintain the contextual policy per user and enforce the policies on a per-user basis, locally within the home location 112. In either embodiment, the SIS 162 can support user modification of the per user settings governing which contextual information is displayed for context data related to that user.

In a specific example of the application of the embodiments with user level granularity, the home monitoring sensor 120 detects temperature fluctuations in the home, which causes the furnace to turn on more often than a pre-established threshold number of times in a set period of time. Reference is made to the components of FIG. 1 in the below descriptions, with the subscriber device being a STB. The sensor reports the event to the SIS 162 through the home monitoring system. In this particular embodiment, all home monitoring events are associated with a specific single user, e.g., the Dad, within the home location 112. Thus table 300 (FIG. 3) maintains an association with temperature fluctuations over a preset threshold with the particular user ID of “Dad”. The SIS 162 stores this detected event in the SIS database 168, under the specified subscriber or user (Dad), and SIS 162 creates a unique reference ID for the event.

Then, at a time that Dad regularly watches programming on his TV, which is connected to a specific subscriber device (e.g., STB), the context mapping module 166 (e.g., an advertisement decision service, ADS, or advertisement decision maker, ADM) requests targeted advertisements about temperature fluctuations within the home for presentation to the TV. In one embodiment, the STB provides intelligence that determines who is currently watching the television, such as user login and STB association. The content mapping module 166 queries the SIS DB 168 for information on the subscriber device and/or the specific user and detects (or receives information about) this new home monitoring event, temperature fluctuation, and the associated user, Dad. Even when it is not explicitly known that Dad is watching a particular TV, the CDS may determine a time of day when (or program that or particular TV where) Dad usually watches television (e.g., from demographic interpolation or historical patterns) and trigger the advertising selection mechanism to insert the specific advertising content into one or more advertising slots available during the content stream at the time of day likely to be watched by the Dad.

The context mapping module 166, based on one or more criteria, such as advertising contracts and/or the mapped context information, causes the content selection mechanism 176 to select the Insulation Co. commercials for this particular user. The content selection mechanism 176 retrieves the targeted Insulation Co. commercial from the Advertisement (Ad) Server 199, and inserts the selected commercial into the MPEG video stream being sent to the STB associated with user ID “Dad”. Specifically, the selected commercial is inserted into normal content that is regularly consumed by Dad at a time slot that would normally be consumed by Dad. The content selection mechanism also includes the reference identifier (unique ID) for the event related to this commercial (e.g., 0x12345678) into the MPEG video stream. The content distribution mechanism selects the particular subscriber device associated with the particular user, Dad. When the content stream is received and the STB begins to play the targeted commercial, the subscriber device (STB) detects the reference identifier from the MPEG stream, and the STB queries the content distribution mechanism 188 for the event related to this reference identifier. In response, content distribution mechanism 188 returns the correlative message (182), e.g., “Temperature fluctuation over Threshold” to the STB. The STB displays a user friendly version of this event to the user during airing of the commercial. In one embodiment, the correlative data returned by the content distribution mechanism 188 can be edited and provided by the advertisers, service providers, and/or the users themselves.

Thus, in the embodiments in which the granularity of the context tracking, content selection, and/or correlative information presentation is at the user level and/or tied to specific subscriber devices that are associated with particular users, the above describe methods of FIGS. 8-10 can be expanded in greater detail to include: the CDS 160 receiving third-party information about the context of a monitored environment of the subscriber device corresponding to at least one of a subscriber, one or more subscriber devices, and one or more users associated with the subscriber. The subscriber has an associated subscriber identifier (ID), the one or more subscriber devices each has a unique subscriber device ID, and the one or more users that are separately indentified each have a unique user ID created within a corresponding subscriber account. The method further includes associating the received information to at least one of the subscriber ID and the user ID of at least one of the one or more separately identified users within a subscriber information service (SIS) database. In one embodiment, the context identified by the received information is correlated to one or more genres and types of targeted content, such as advertising content.

In one embodiment, the context is related to the occurrence of at least one event within the monitored environment and the correlative information explains why, in light of the context, specific content is being presented. The method then further includes: receiving from one or more sources the information utilized to determine when to include the correlative information with the targeted advertisement; determining, by analyzing the one or more types of information received, whether correlative information should be transmitted along with the targeted content; and in response to determining that the correlative information should be transmitted, generating the correlative information and scheduling the correlative information to be transmitted along with the targeted content. The content distribution mechanism then determines, by analyzing one or more types of contextual user data corresponding to respective user IDs maintained within the subscriber account in the SIS database, which particular user of the one or more separately identified users should received the targeted advertisement. After the specific user is identified and the subscriber device associated with that user is known, the content distribution mechanism schedules the transmitting of the specific advertising content to target the particular user identified as the one who should receive the targeted advertisement. According to one implementation, the content distribution mechanism schedules the transmitting of the specific content by first determining a type of content that is regularly consumed by the particular user by analyzing historical data associated with the user ID of the particular user. After this, the content distribution mechanism determines which user device or devices to optimally stream the specific content. In one embodiment, the content distribution mechanism can also determine a time of day during which the particular type of content is streamed to the subscriber device, and then insert the specific advertising content into one or more advertising slots available during transmission of the type of content within the content stream at the time of day at which the content is streamed to the user.

When user level granularity is utilized, the receipt of negative information (e.g., (i) not receiving any updated information within the pre-established time period following initial transmission of the targeted advertisement or (ii) receiving updated information that does not indicate the expected response) causes the SIS to reduce a level of association between the type of event and the particular user ID within the SIS database and reducing (or stopping) future transmission of the specific content to this particular user. The SIS then selects a second particular user ID to target with the targeted advertisement, and then transmits the specific advertising content and the correlative information in advertising time slots within a content stream that is historically consumed by a user associated with the second particular user ID. In one embodiment, the SIS first performs a new determination that the correlative information should be transmitted to the second particular user before including correlative information with the transmission of the specific content. Also, if no updated information was received during the pre-established time period, the content distribution mechanism determines if the content should be streamed to another user device. If there are other existing subscriber devices associated with different users in the environment, then the content distribution mechanism selects another user and device to transmit the specific content and correlative information to.

One embodiment supports the CDS providing within the content stream one or more coded modules that generate selectable options at the subscriber device for capturing and transmitting feedback response to at least one of the specific advertising content and the correlative information. In yet another embodiment, the CDS determining a level of sensitivity associated with one or more of the received information, the event, and the correlative information. Then, in response to the level of sensitivity being greater than a pre-set sensitivity threshold that requires at least one of privacy and security before presenting the correlative information: the CDS initiates a privacy protocol for displaying the correlative information. The particular privacy protocol can be one or more of: withholding transmission of the correlative information until a pre-established user code is received via the subscriber device; encoding the correlative information to require a specific sequence of button selections at the subscriber device prior to presenting the correlative information to an end user device; transmitting the correlative information when the end user device of the particular user is one of a pre-set personal device and a secure device; and transmitting the correlative information to the particular user via another communication medium separate from the content stream.

In yet another embodiment, the CDS determines one of a priority level, a seriousness level, and a level of urgency associated with the event identified by the received information. Then, in response to at least one of the priority level, the seriousness level, and the level of urgency being above a respective pre-set threshold level, the CDS modifies a manner of outputting the targeted advertisement. In one implementation, the CDS modifies the outputting of the targeted advertising by one or more of: increasing a frequency of presenting the targeted advertisement; changing one or more display characteristics of the correlative information to indicate an increased priority level, seriousness level, or level of urgency associated with the event that triggered the transmission of the targeted advertisement; extending a time period over which the targeted advertisement is presented with the correlative information to the subscriber device; bypassing established user contexts linking the event to a particular user ID and presenting the targeted advertisement and the correlative information to all subscriber devices regardless of the user ID associated with the subscriber devices; or triggering a communication of the correlative information to the particular user via an alternate communication medium. Additionally, in one embodiment, the CDS maintains a display of the correlative information during presentation of the content stream independent of the targeted advertisement.

In one embodiment, the specific advertising content includes video content for display on an end user device and the selectable affordance is an icon that is displayed along with the targeted advertisement on the end user device. The CDS then encodes the icon to present one or more display characteristics corresponding to one or more of characteristics associated with at least one of the event and the correlative information from among: a level of importance, a level of privacy, a security level, a level of urgency, the particular user to which the correlative information is directed, whether access to the correlative information requires entry of a security password, whether access to the correlative information requires selection of a particular sequence of buttons on one of the end user device, the subscriber device and a remote control device. The CDS also enables the correlative information to be displayed along with the targeted advertisement following receipt of a selection of the icon and entry of any required security credentials, including one or more of a password and selection of the particular sequence of buttons. With this pre-condition, the correlative information is not displayed unless the required security credentials are provided at the subscriber device. In one implementation, where the selectable affordance is an icon, selection of the icon on a display of the end user device causes the icon to be replaced by a visual depiction of the correlative information on the display.

One or more program modules execute on the one or more processors to generate the subscriber information service (SIS). The subscriber information database is managed by the subscriber information service and stores (i) identifying information for at least one subscriber account and one or more user identifiers (IDs) associated with the subscriber account and (ii) contextual data related to at least one of the subscriber account and one or more of the one or more user IDs, wherein the subscriber account has an associated subscriber identifier (ID). The SIS receives information related to the context of interest that occur within a subscriber environment, wherein the context is detected by the one or more sensors located within the subscriber environment or is provided by user entry of information via one or more input mechanisms. In one embodiment, responsive to receipt of information by the SIS that indicates the occurrence of a specific event, the content selection mechanism: associates the received information to at least one of the subscriber ID and the user ID of at least one of the one or more separately identified users within a subscriber information service (SIS) database; correlates the at least one event identified by the received information to one or more genres and types of advertising content; selects, based on the received information and (optionally) contextual data stored within the SIS database, specific advertising content to provide to a select one or more of the subscriber devices associated with the subscriber ID, where the specific advertising content is a targeted advertisement based on the occurrence of the at least one event within the monitored environment and (optionally) where the select one or more of the subscriber devices are contextually linked to one or more specific user IDs; inserts the specific advertising content into a content stream being transmitted to the select one or more of the subscriber devices; and enables the content retrieval and transmittal mechanism to transmit, along with the specific advertising content, at least one of (a) correlative information explaining a context surrounding why the specific advertising content is being presented and (b) a selectable affordance by which access to the correlative information is provided, where the context is related to the occurrence of the at least one event within the monitored environment.

Further, in one embodiment, the CDS stops transmitting the targeted advertisement at the advertising time slots of the content stream in response to one or more of: (a) receipt of updated event information that indicates that corrective action has been taken; (b) passage of a pre-established maximum time period during which the targeted advertisement has been presented and corrective action has not been initiated; and (c) receipt of an update to the contextual data associated with one of the subscriber ID and the particular user ID, wherein the update indicates that the targeted advertisement triggered by occurrence of the event is no longer required for that particular user ID.

Also, to schedule the transmitting of the specific advertising content, the SIS: in response to the subscriber location having multiple subscriber devices that are granularly linked via contextual data to specific user IDs among the one or more user IDs, selects, based on the contextual data associated with the user IDs, a particular subscriber device of the multiple subscriber devices, wherein the particular subscriber device is one that is more likely to be utilized for content consumption by the particular user; in response to selecting a particular subscriber device, the CDS transmits the specific advertising content and the at least one of the correlative information and the selectable affordance for the correlative information to that particular subscriber device; monitors for receipt of updated information about the at least one event indicating one or more of (a) a change in the at least one event occurring subsequent to initiating transmission of the targeted advertisement and (b) a user entry of a modification to relevant contextual data; in response to (i) the updated information being received within a pre-established time period following transmission of the targeted advertisement and (ii) the updated information indicating an expected response when the targeted advertisement is received and responded to by one of the users within the monitored environment, updates a context mapping within the SIS database to confirm a recent successful correlation between the type of event and the targeted advertisement with at least one of the particular user ID and the particular subscriber device.

Further, in response to at least one of (i) not receiving any updated information within the pre-established time period following initial transmission of the targeted advertisement and (ii) receive updated information that does not indicate the expected response: the CDS reduces a level of association within the SIS database between the type of event, the particular user ID, and the particular subscriber device; selects a second particular subscriber device to transmit the specific advertising content to; transmits the specific advertising content in advertising time slots within a content stream that is being transmitted to the second particular subscriber device; and transmits the correlative information along with the specific advertising content in response to a new determination that the correlative information should be transmitted to the second particular subscriber device.

In the above detailed description of exemplary embodiments of the disclosure, specific exemplary embodiments in which the disclosure may be practiced are described in sufficient details to enable those skilled in the art to practice the disclosure, and it is to be understood that other embodiments may be utilized and that logical, architectural, programmatic, mechanical, electrical and other changes may be made without departing from the spirit or scope of the present innovation. The following detailed description is, therefore, not to be taken in a limiting sense, and the scope of the present disclosure is defined by the appended claims and equivalents thereof.

It is understood that the use of specific component, device and/or parameter names (such as those of the executing utility/logic described herein) are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

As will be appreciated by one skilled in the art, aspects of the present invention may be embodied as a system and a method Furthermore, aspects of the present invention may take the form of a computer program product embodied in one or more computer readable medium(s) having computer readable program code embodied thereon.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means and/or logic for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for selectively distributing content from a backend content distribution system (CDS) to at least one subscriber device, the method comprising:
receiving information from a monitored environment to which a subscriber device of the at least one subscriber device is associated;
correlating, using a processor of the backend CDS, a context identified by the received information to a specific content;
inserting the specific content into a content stream being transmitted to the subscriber device; and
transmitting along with the specific content at least one of (a) correlative information explaining the context surrounding why the specific content is being presented and (b) a selectable affordance by which access to the correlative information is provided.

2. The method of claim 1, further comprising:
determining, by analyzing the received information, whether the correlative information should be transmitted along with the specific content, wherein the received information comprises at least one of (a) sensor information received from a sensor located within the monitored environment and (b) detected subscriber behavior captured by the subscriber device, and (c) subscriber-provided context information; and
in response to determining that the correlative information should be transmitted, generating the correlative information and scheduling the correlative information to be transmitted along with the specific content.

3. The method of claim 1, further comprising:
determining, by analyzing historical data, a type of content that is regularly consumed via the subscriber device; and
inserting the specific content into one or more slots available during transmission of the type of content within the content stream to the subscriber device.

4. The method of claim 1, further comprising:
monitoring for receipt of updated information indicating one or more of (a) a change in at least one sensor context subsequent to the transmitting and (b) a user entry of a modification to subscriber-provided context information;
updating a context mapping to confirm a recent successful correlation between at least one of the received information, the specific content, and the correlative information with the subscriber device;

5. The method of claim 4, further comprising:
in response to at least one of (i) not receiving any updated context information within a pre-established time period following the transmitting and (ii) receiving updated context information that does not indicate an expected response, reducing a level of association between the received information and a subscriber device ID and reducing future transmission of the specific content to the subscriber device.

6. The method of claim 5, further comprising:
initiating a transmission of the specific content and the correlative information to a second subscriber device, in response to an inclusion of the second subscriber device within the monitored environment.

7. The method of claim 1, further comprising:
detecting receipt of a negative feedback response to the correlative information, where the negative feedback response indicates that a first user of the subscriber device does not want to receive at least one of the specific content and the correlative information; and
in response to the detecting receipt of the negative feedback response, suspending an insertion into the content stream of at least one of the specific content and the correlative information targeting the first user, selecting a second user to target with the specific content and the correlative information, wherein the first user and the second user are both associated with the subscriber device within a subscriber account, and forwarding the specific content and the correlative information within a content stream that targets the second user.

8. The method of claim 1, further comprising:
in response to receiving a positive feedback response to the correlative information, updating a correlation based on the positive feedback response and modifying a schedule for inserting the specific content into the content stream based on the updated correlation.

9. The method of claim 1, further comprising:
in response to receiving updated sensor information that indicates that a positive response has been provided in response to receipt at the subscriber device of at least one of the specific content and the correlative information, reducing an enhanced schedule for inserting the specific content into the content stream to a normal schedule.

10. The method of claim 1, further comprising:
determining at least one of a priority level, a seriousness level, a sensitivity level, and an urgency level associated with the received information;
modifying one or more output parameters and characteristics of at least one of the specific content and the correlative information based on one or more of the priority level, the seriousness level, the sensitivity level, and the urgency level.

11. The method of claim 1, wherein the specific content comprises video content for display on an end user device and wherein the selectable affordance is an icon that is displayed along with the specific content on the end user device, the method further comprising:
encoding the icon to present one or more display characteristics corresponding to one or more characteristics associated with at least one of the received information, the specific content and the correlative information; and
enabling the correlative information to be displayed along with the specific content following receipt of feedback indicating a selection at the subscriber device of the icon and an entry of any required security credentials;
wherein said correlative information is not displayed unless the required security credentials are provided at the subscriber device.

12. The method of claim 1, wherein the specific content is targeted advertising and the correlative information is at least one of: a text-based message and a graphic.

13. A content distribution system comprising:
a server having at least one processor, at least one memory coupled to the at least one processor, and one or more program modules that execute on one or more processors of the at least one processor to generate a subscriber information service (SIS), wherein the server is communicatively coupled to at least one subscriber device within a corresponding subscriber environment;
a content distribution mechanism associated with the server and which transmits content, via a transmission medium connected to the server, to the at least one subscriber device;
a context module of the SIS that:
receives contextual information associated with one or more contexts related to one or more of a subscriber and the corresponding subscriber environment; and
associates the received contextual information to at least one of the subscriber and a subscriber device;
a content selection mechanism that, responsive to the contextual information received by the context module:
selects, based on the received contextual information, a specific content to provide to the subscriber via the subscriber device; and
inserts the specific content into a content stream being transmitted to the subscriber device; and
a correlation engine that:
correlates the received contextual information to the selected specific content; and
triggers the content distribution mechanism to transmit, along with the specific content, at least one of (a) correlative information explaining why the specific content is being presented and (b) a selectable affordance by which access to the correlative information is provided.

14. The content distribution system of claim 13, wherein further:
the content selection mechanism: determines, by analyzing historical data, a type of content that is regularly consumed via the subscriber device; and inserts the specific content into one or more slots available during transmission of the type of content within the content stream to the subscriber device; and
the correlation engine: determines, by analyzing the received information, whether the correlative information should be transmitted along with the specific content, wherein the received information comprises at least one of (a) sensor information received from a sensor located within the subscriber environment and (b) detected subscriber behavior captured by the subscriber device, and (c) subscriber-provided context information; and in response to determining that the correlative information should be transmitted, generates the correlative information and schedules the correlative information to be transmitted along with the specific content.

15. The content distribution system of claim 14, wherein the correlation engine further:
determines when to forward the selectable affordance in lieu of the correlative information;
generates the selectable affordance and forwards the selectable affordance to the content distribution mechanism in place of the correlative information;
when the specific content comprises video content for display on an end user device, provides the selectable affordance as an icon that can be displayed along with the specific content on the end user device, encodes the icon to present one or more display characteristics corresponding to one or more characteristics associated with at least one of the received contextual information, the specific content and the correlative information; and enables the correlative information to be displayed along with the specific content following receipt of a selection of the icon and entry of any required security credentials; and
responsive to receipt of a feedback signal indicating a selection of the selectable affordance at the subscriber device, forwards the correlative information to the content distribution mechanism for transmission to the subscriber device.

16. The content distribution system of claim 14, further comprising:
a subscriber information service (SIS) database managed by the subscriber information service and in which is stored (i) identifying information associated with the subscriber device; and (ii) received contextual information related to the subscriber and the corresponding subscriber environment; and
wherein the contextual information comprises subscriber provided contextual information and events and activities occurring at the subscriber environment that are monitored by the sensor to generate the sensor information that is transmitted to the SIS.

17. The content distribution system of claim 16, wherein the context module of the SIS further:
monitors for receipt of updated context information indicating a detected change in at least one sensor context subsequent to the transmitting;
in response to the receipt of updated context information, updates a context mapping to confirm a recent successful correlation between at least one of the received information, the specific content, and the correlative information with the subscriber;
in response to (i) the updated contextual information being received within a pre-established time period following transmission of the specific content and (ii) the updated contextual information indicating a positive response to a receipt by an end user within the subscriber environment of the specific content: updates the context mapping within the SIS database to confirm the recent successful correlation between two or more of the received contextual information, the specific content, and the correlative information with a particular subscriber device; and modifies a schedule for inserting the specific content into the content stream based on the updated contextual information; and
in response to at least one of (i) not receiving any updated contextual information within the pre-established time period following initial transmission of the specific content and (ii) receiving updated contextual information that does not indicate the positive response: reduces a level of association within the SIS database between the received contextual information, the specific content, and the correlative information with the particular subscriber device.

18. The content distribution system of claim 16, wherein the context module of the SIS further:
monitors for receipt of updated context information indicating a user entry of at least one of a response to and a modification of the context information; in response to receiving a positive feedback response to the correlative information, updates a correlation based on the positive feedback response and modifies a schedule for inserting the specific content into the content stream based on the updated correlation;
detects receipt of a negative feedback response to the correlative information, where the negative feedback response indicates that a user of the subscriber device does not want to receive at least one of the specific content and the correlative information; and
in response to detecting receipt of the negative feedback response, suspends an insertion into the content stream of at least one of the specific content and the correlative information.

19. The content distribution system of claim 13, wherein the context module further:
determines at least one of a priority level, a seriousness level, a sensitivity level, and an urgency level associated with the received information;
modifies one or more parameters and characteristics of at least one of the specific content and the correlative information based on one or more of the priority level, the seriousness level, the sensitivity level, and the urgency level.

20. The content distribution system of claim 13, wherein the specific content comprises video content for display on an end user device and wherein the selectable affordance is an icon that is displayed along with the specific content on the end user device, and the correlation engine: encodes the icon to present one or more display characteristics corresponding to one or more characteristics associated with at least one of the received information, the specific content and the correlative information; and enables the correlative information to be displayed along with the specific content following receipt of feedback indicating a selection at the subscriber device of the icon and an entry of any required security credentials; wherein said correlative information is not displayed unless the required security credentials are provided at the subscriber device.
